(19) United States
(12) Patent Application Publication
(10) Pub. No.: US 2016/0118690 A1
(43) Pub. Date: Apr. 28, 2016

(54) FLUORINATED CARBONATES AS SOLVENT FOR LITHIUM SULFONIMIDE-BASED ELECTROLYTES

(71) Applicants: SOLVAY FLUOR GMBH, Hannover (DE); WESTFÄLISCHE WILHELMS-UNIVERSITÄT MÜNSTER, Münster (DE); INSTITUT POLYTECHNIQUE DE GRENOBLE, Grenoble (FR); CNRS- CENTRE NATIONAL DE LA RECHERCHE SCIENTIFIQUE, Paris Cedex 16 (FR)

(72) Inventors: Martin BOMKAMP, Hannover (DE); Julian KALHOFF, Münster (DE); Dominic BRESSER, Münster (DE); Stefano PASSERINI, Münster (DE); Marco BOLLOLI, Grenoble (FR); Fannie ALLOIN, Vizille (FR); Jean-Yves SANCHEZ, Saint-Ismier (FR)

(21) Appl. No.: 14/888,536

(22) PCT Filed: May 2, 2014
(86) PCT No.: PCT/EP2014/059011

§ 371 Date: Nov. 2, 2015

(30) Foreign Application Priority Data
May 2, 2013 (EP) 13305576.4

(51) Int. Cl. H01M 10/0569; H01M 10/0568; H01M 4/66; H01M 10/0525

(52) U.S. Cl. CPC H01M 10/0569; H01M 10/0525; H01M 10/0568; H01M 4/661; H01M 2300/0034; H01M 2300/0037; H01M 2300/004

(57) ABSTRACT

The present invention relates to an electrolyte solution comprising an electrolyte salt and an electrolyte solvent, wherein the electrolyte solvent comprises a fluorinated acyclic dialkyl carbonate, preferably an n-fluoro diethyl carbonate according to formula (1) as follows: C₂H₅₋ₓFₓ—CO₃C₂H_{5-y}F_{y} (1) wherein 1≦x≦5 and 0≦y≦5; in an amount in the range of ≧10 wt % to ≦100 wt %, referring to a total amount of the electrolyte solvent of 100 wt %, and the use of such fluorinated acyclic dialkyl carbonates for the prevention or suppresion of aluminum current collector corrosion in an alkali or alkaline earth metal-based electrochemical energy storage device, particularly in a lithium-ion battery or lithium polymer battery containing an electrolyte solution comprising an alkali or alkaline earth metal sulfonimide or sulfonmethide salt.

This application claims priority to EP 13 305 576.4 filed on May 2, 2013, the whole content of this application being incorporated herein by reference for all purposes.

The present invention relates to an electrolyte solution comprising an electrolyte salt, particularly a sulfonimide salt, and an electrolyte solvent for use in lithium and lithium-ion batteries.

Lithium-ion batteries are nowadays the leading battery technology, since they offer efficient and high energy storage as well as high power density, and thus, they dominate the market for batteries used in portable electronic devices. However, future large-scale applications like stationary energy storage and electric vehicles still require further improvement of the existing technology in terms of energy density, supplied power, and in particular in terms of safety. One of the major safety issues regarding the up-scaling of lithium-ion battery technology, particularly with respect to its application in electric vehicles, is related to the use of LiPF₆ as lithium salt in currently commercially available batteries. In fact, LiPF₆ does not have any single exceptional property, making it particularly attractive for application as lithium salt in commercial batteries. However, besides a well-balanced combination of chemical and electrochemical properties it offers one major advantage relatively to other lithium salts, the initial passivation of the aluminum surface of the cathodic current collector, caused by the partial decomposition of the lithium salt and oxidation of the metallic aluminum at high potentials, forming a dense film of AlF₃ on the top of the air-formed surface layer of Al₂O₃. Nevertheless, there arise some major issues by the use of LiPF₆, as it is thermally unstable, resulting in the formation of gaseous PF₅, a strong Lewis acid. Moreover, its hydrolysis results in the formation of HF, which is not only highly toxic, but furthermore has a deleterious effect on the electrolyte solvent as well as the electrodes active materials. Finally, a reaction of ethylene carbonate and LiPF₆ at high temperatures and in presence of transition metal based cathodes has been reported to result in the formation of highly toxic fluoroethanol derivatives.

Hence, research on electrolytes for lithium-based batteries has focused on the development and investigation of new lithium salts, replacing LiPF₆ and offering an enhanced thermal, chemical, and electrochemical stability. One of the most promising salts is certainly lithium bis(trifluoromethanesulfonyl)imide or briefly LiTFSI as it provides a high ionic conductivity and a significantly improved thermal and electrochemical stability relatively to LiPF₆. Additionally, the immediate formation of HF by hydrolysis of the salt is prevented. However, LiTFSI severely suffers aluminum current collector corrosion (aluminum dissolution) at potentials higher than 3.5 V, which has so far inhibited its application in commercial lithium-based batteries. This oxidative decomposition of the aluminum current collector causes an increase of the internal resistance of the cell, resulting in a continuous capacity fading and thus a decrease of the specific energy. Moreover, a continuous decomposition of the aluminum might eventually result in a loss of the mechanical integrity of the current collector to the outer circuit.

Several approaches have been pursued in order to overcome the issue of aluminum current collector corrosion for LiTFSI-based lithium battery electrolytes, for example the utilization of ether-based solvents, such as e.g. THF or DME, which allow for a reduction of the aluminum corrosion and a shift of oxidative current collector decomposition towards higher potentials but can not completely suppress the corrosion phenomenon, or the use of nitrile based electrolyte solvents, comprising at least one cyano group, which appeared to have a beneficial effect on the suppression of aluminum corrosion, resulting in an overpotential of around 0.4 V for the aluminum dissolution. However, aluminum corrosion still takes place at potentials higher than 4.1 V. Also, the use of ionic liquids as electrolyte solvent has shown a significant suppression of the aluminum current collector corrosion. However, the commercial use of ionic liquids as electrolyte solvents is still hampered by its high cost and low ionic conductivity at ambient temperature. Furthermore, a coating of the aluminum current collector has been reported to suppress the aluminum dissolution upon cycling of lithium(-ion) cells. However, such a coating of the current collector leads to the requirement of additional processing steps and thus increasing cost, particularly if rather expensive materials are used for the coating.

US 2005/0031963 A1 addresses the problem of the safety of lithium battery and the use of flame retardant electrolytes. It is disclosed that an electrolyte solvent comprising 20 to 60% by volume of a cyclic fluoroethylene carbonate and a linear ester solvent, such as for instance dimethyl or diethyl carbonate, results in an enhanced safety of the battery comprising the same.

Thus, there still is need for the suppression and prevention of aluminum current collector corrosion resulting from the use of LiTFSI as lithium salt in liquid organic electrolytes in order to improve the safety of lithium(-ion) batteries, particularly with respect to large scale applications, as for instance electric vehicles or stationary energy storage.

Therefore, it is one objective of the present invention to provide a means usable for the suppression or prevention of aluminum current collector corrosion in an alkali or alkaline earth metal-based electrochemical energy storage device. More specifically, it is an objective of the present invention to provide a means usable for the suppression or prevention of aluminum current collector corrosion resulting from the use of an alkali or an alkaline earth metal sulfonimide or sulfonmethide salt such as LiTMSI as electrolyte salt in a lithium ion battery.

At least this problem is solved by an electrolyte solution comprising an electrolyte salt and an electrolyte solvent, wherein the electrolyte solvent comprises a fluorinated acyclic dialkyl carbonate in an amount in the range of ≧10 wt % to ≦100 wt %, preferably in an amount in the range of ≧20 wt % to ≦100 wt %, referring to a total amount of the electrolyte solvent of 100 wt %.

The term “fluorinated acyclic dialkyl carbonate” is intended to denote a compound of the general formula R1-O—C(O)—O—R2, wherein R1 and R2 are independently selected from a branched or unbranched alkyl group and wherein at least one of the groups R1 and R2 is substituted by at least one fluorine atom. R1 and R2 may be the same or may be different. Examples of the branched or unbranched alkyl group according to this invention include methyl, ethyl, n-propyl, isopropyl, n-butyl, isobutyl and tert-butyl. Examples of the groups R1 and R2 substituted by at least one fluorine atom according to this invention include fluoromethyl, difluoromethyl, trifluoromethyl, 2-fluoroethyl, 1-fluoroethyl, 2,2-difluoroethyl, 1,1-difluoroethyl and 2,2,2-trifluoroethyl. Specific examples of a “fluorinated acyclic dialkyl carbonate” according to this invention include fluoromethyl methyl carbonate, bis(fluoromethyl)carbonate, fluoromethyl ethyl carbonate, fluoromethyl n-propyl carbonate, fluoromethyl isopropyl carbonate, 1-fluoroethyl methyl carbonate, 2-fluoroethyl methyl carbonate, 1-fluoroethyl ethyl carbonate, 2-fluoroethyl ethyl carbonate, 2,2,2-trifluoroethyl methyl carbonate, 2,2,2-trifluoroethyl ethyl carbonate, 2,2,2-trifluoroethyl 1-fluoroethyl carbonate, 2,2,2-trifluoroethyl 2-fluoroethyl carbonate, 2,2,2-trifluoroethyl fluoromethyl carbonate, 2,2-difluoroethyl methyl carbonate, 2,2-difluoroethyl ethyl carbonate, 2,2-difluoroethyl 1-fluoroethyl carbonate, 2,2-difluoroethyl 2-fluoroethyl carbonate and 2,2-difluoroethyl fluoromethyl carbonate, preferably fluoromethyl methyl carbonate, bis(fluoromethyl)carbonate, fluoromethyl ethyl carbonate, fluoromethyl n-propyl carbonate, fluoromethyl isopropyl carbonate, 1-fluoroethyl methyl carbonate, 2-fluoroethyl methyl carbonate, 2,2,2-trifluoroethyl methyl carbonate, 2,2,2-trifluoroethyl fluoromethyl carbonate, 2,2-difluoroethyl methyl carbonate, and 2,2-difluoroethyl fluoromethyl carbonate.

In a preferred embodiment, the electrolyte solution comprises an electrolyte salt and an electrolyte solvent, wherein the electrolyte solvent comprises an n-fluoro diethyl carbonate according to formula (1) as follows:

C₂H₅₋ₓFₓCO₃C₂H_{5-y}F_{y} (1) wherein 1≦x≦5 and 0≧y≦5 in an amount in the range of ≧10 wt % to ≦100 wt %, preferably in an amount in the range of ≧20 wt % to ≦100 wt %, referring to a total amount of the electrolyte solvent of 100 wt %.

In another preferred embodiment, the electrolyte solution comprises an electrolyte salt and an electrolyte solvent, wherein the electrolyte comprises a fluorinated acyclic dialkyl carbonate in an amount in the range of ≧10 wt % to ≦100 wt %, preferably in an amount in the range of ≧20 wt % to ≦100 wt %, and is selected from the group consisting of a dimethyl carbonate, an ethyl methyl carbonate, a methyl propyl carbonate, an ethyl propyl carbonate, a dipropyl carbonate or mixtures thereof, preferably the fluorinated dialkyl carbonate is selected from the group consisting of fluoromethyl methyl carbonate, bis(fluoromethyl)carbonate, fluoromethyl ethyl carbonate, fluoromethyl n-propyl carbonate, fluoromethyl isopropyl carbonate, 1-fluoroethyl methyl carbonate, 2-fluoroethyl methyl carbonate, 2,2,2-trifluoroethyl methyl carbonate, 2,2,2-trifluoroethyl fluoromethyl carbonate, 2,2-difluoroethyl methyl carbonate, and 2,2-difluoroethyl fluoromethyl carbonate.

Surprisingly, it was found that the prevention of aluminum current collector corrosion while using LiTFSI-based electrolytes could be achieved by utilizing linear or acyclic fluorinated dialkyl carbonates as electrolyte solvent. Surprisingly, the utilization of linear or acyclic fluorinated dialkyl carbonates as electrolyte solvent for LiTFSI-based electrolytes revealed a similar electrochemical behavior as observed for the utilization of LiPF₆ as lithium salt. Advantageously, no aluminum corrosion could be observed on the aluminum foil current collector subsequently, even after 100 potentiodynamic cyclic sweeps. Such prevention of aluminum corrosion in combination with the use of LiTFSI is surprising and has never been reported before.

Further, electrochemical studies using common lithium-ion battery cathode materials confirmed that electrolyte compositions comprising ≧20 wt % of linear fluorinated carbonates can be readily used for lithium-ion cells and are sufficiently stable towards oxidation, also in presence of transition metal oxides and phosphates, delivering a highly similar specific capacity, cycling stability, and electrochemical performance as observed for commercial lithium-ion cells using 1M LiPF₆ in EC:DMC (1:1).

Particularly, the electrolyte solution comprising ≧10 wt %, preferably ≧20 wt % of a fluorinated acyclic dialkyl carbonate, preferably of an n-fluoro diethyl carbonate according to formula (1) C₂H₅₋ₓFₓCO₃C₂H_{5-y}F_{y} wherein 1≦x≦5 and 0≦y≦5 is usable for electrolyte solutions comprising a sulfonimide electrolyte salt and using an aluminum current collector.

In an embodiment, the electrolyte salt is an alkali or alkaline earth metal sulfonimide or sulfonmethide salt. The sulfonimide salt preferably is selected from lithium, sodium, potassium, magnesium, or calcium metal sulfonimides. Preferably, the sulfonimide salt is a lithium salt selected from the group consisting of lithium bis(trifluoromethanesulfonyl)imide LiN(SO₂CF₃)₂ (LiTFSI), lithium bis(fluorosulfonyl)imide (LiFSI), LiN(FSO₂)₂, lithium trifluoromethanesulfonate Li(CF₃)SO₃ (LiTf), lithium (trifluoromethylsulfonyl)(nonafluorobutanesulfonyl)imide LiN(SO₂CF₃)(SO₂C₄F₉), lithium (fluorosulfonyl)(nonafluorobutanesulfonyl)imide LiN(SO₂F)(SO₂C₄F₉), lithium (nonafluoro butan-2-one sulfonyl)(trifluoromethylsulfonyl)imide LiN(SO₂C₂F₄OC₂F₅)(SO₂CF₃), and lithium(nonafluoro butan-2-one sulfonyl)(fluorosulfonyl)imide LiN(SO₂C₂F₄OC₂F₅)(SO₂F). Preferred lithium sulfonimide salts are bis(trifluoromethanesulfonyl)imide LiN(SO₂CF₃)₂ (LiTFSI), lithium bis(fluorosulfonyl)imide (LiFSI), lithium trifluoromethanesulfonate Li(CF₃)SO₃ (LiTf) and mixtures thereof.

Sulfonimide-based lithium salts provide a high ionic conductivity and show enhanced thermal and electrochemical stability. Further, the immediate formation of HF by hydrolysis as may occur with LiPF₆ is prevented.

Particularly the anodic aluminum dissolution, which usually is referred to as “corrosion” and from which the utilization of sulfonimide-based lithium salts suffered, can be prevented by using a linear fluorinated carbonate according to the invention. Hence, the use of sulfonimide-based lithium salts such as LiTFSI will result in significantly safer lithium-ion batteries, as the severe anodic dissolution of aluminum current collectors particularly at potentials above 3.5 V is prevented using the linear fluorinated carbonates of the invention. Particularly LiTFSI, LiFSI (lithium bis(fluorosulfonyl)imide) and Li Triflate, which are known to suffer anodic aluminum dissolution, can advantageously be utilized as lithium salt for (fluorinated) organic carbonate-based electrolytes in lithium-ion batteries by adding a linear fluorinated carbonate according to the invention. Further, it could be shown that also for lithium(nonafluoro butan-2-one sulfonyl)(trifluoromethylsulfonyl)imide LiN(SO₂C₂F₄OC₂F₅)(SO₂CF₃) in a solvent mixture of 4-fluoro-1,3-dioxolan-2-one (F₁EC), ethyl (1-fluoroethyl)carbonate (F₁DEC) and 1-fluoroethyl(2,2,2-trifluoroethyl)carbonate (F₄DEC) aluminum dissolution could be prevented.

The sulfonmethide salt preferably is LiC(CF₃SO₂)₃. Also sulfonmethide salts such as LiC(CF₃SO₂)₃ are electrolyte salts that likely will induce aluminum corrosion.

The n-fluoro diethyl carbonate C₂H₅₋ₓFₓCO₃C₂H_{5-y}F_{y} (1) wherein 1≦x≦5 and 0≦y≦5 comprises at least one fluoro substituent. The fluorinated linear carbonate at each ethyl group may comprise one, two, three or more fluoro substituents and/or at least a 1-fluoroethyl group, a 2-fluoroethyl group, a 2,2,2-trifluoroethyl group or a pentafluoroethyl group. Hence, in formula (1) x may be an integer of 1, 2, 3, 4 or 5, while y may be an integer of 0, 1, 2, 3, 4 or 5. In an embodiment, the n-fluoro diethyl carbonate is selected from the group consisting of ethyl (1-fluoroethyl)carbonate, 1-fluoroethyl(2,2,2-trifluoroethyl)carbonate, bis(2-fluoroethyl)carbonate, bis(2,2,2-trifluoroethyl)carbonate, bis(1,2,2-trifluoroethyl)carbonate and mixtures thereof. Preferably the n-fluoro diethyl carbonate is selected from the group consisting of ethyl (1-fluoroethyl)carbonate, 1-fluoroethyl(2,2,2-trifluoroethyl)carbonate and mixtures thereof.

The corresponding chemical formulas of ethyl (1-fluoroethyl)carbonate (F₁DEC) and 1-fluoroethyl(2,2,2-trifluoroethyl)carbonate (F₄DEC), respectively, are given below:

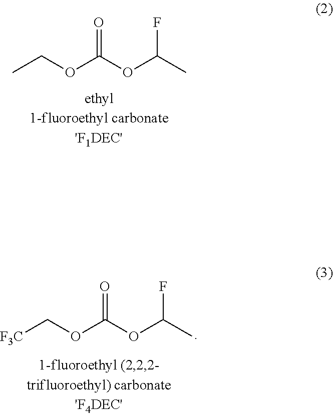

It could be shown that particularly the utilization of ethyl (1-fluoroethyl)carbonate (F₁DEC) or 1-fluoroethyl(2,2,2-trifluoroethyl)carbonate (F₄DEC) as electrolyte solvent for LiTFSI-based electrolytes resulted in the prevention of anodic aluminum dissolution and no corrosion was observed for the aluminum foil used as current collector, even after 100 potentiodynamic cyclic sweeps. Hence, an electrolyte solution may comprise an unary solution of ethyl (1-fluoroethyl)carbonate or 1-fluoroethyl(2,2,2-trifluoroethyl)carbonate as the electrolyte solvent.

Advantageously, a study on the conductivity of these primary electrolyte solvents comprising LiTFSI as lithium salt revealed that the ionic conductivity can be further improved by utilizing secondary or ternary solvent mixtures of linear or acyclic together with cyclic fluorinated carbonates. So, in an embodiment, the electrolyte solvent further comprises at least one cyclic fluorinated carbonate selected from the group consisting of 4-fluoro-1,3-dioxolan-2-one, 4,5-difluoro-1,3-dioxolan-2-one particularly cis-4,5-difluoro-1,3-dioxolan-2-one or trans-4,5-difluoro-1,3-dioxolan-2-one, and mixtures thereof. 4-Fluoro-1,3-dioxolan-2-one (F₁EC) and trans-4,5-difluoro-1,3-dioxolan-2-one (F₂EC) are represented by the following formulas (4) and (5), respectively:

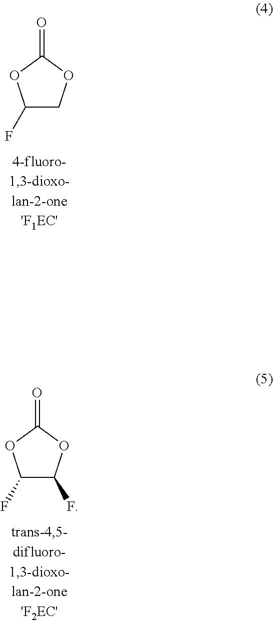 [SMILES: O=C1OCC(F)O1 ; O=C1O[C@@H](F)[C@H](F)O1]

In embodiments, the electrolyte solution comprises a binary solvent mixture of a fluorinated acyclic dialkyl carbonate, preferably of an n-fluoro diethyl carbonate according to formula C₂H₅₋ₓFₓCO₃C₂H_{5-y}F_{y} (1) wherein 1≦x≦5 and 0≦y≦5, and a cyclic fluorinated carbonate selected from the group consisting of 4-fluoro-1,3-dioxolan-2-one (F₁EC), cis-4,5-difluoro-1,3-dioxolan-2-one, and trans-4,5-difluoro-1,3-dioxolan-2-one. Preferably, the electrolyte solution comprises a binary solvent mixture of ethyl (1-fluoroethyl)carbonate or 1-fluoroethyl(2,2,2-trifluoroethyl)carbonate and a cyclic fluorinated carbonate selected from the group consisting of 4-fluoro-1,3-dioxolan-2-one, cis-4,5-difluoro-1,3-dioxolan-2-one, and trans-4,5-difluoro-1,3-dioxolan-2-one. It could be shown that the conductivity of binary solvent mixtures was higher than that of the linear or acyclic carbonates alone.

The binary solvent mixture may comprise a mixture of ethyl (1-fluoroethyl)carbonate or 1-fluoroethyl(2,2,2-trifluoroethyl)carbonate and 4,5-difluoro-1,3-dioxolan-2-one, particularly trans-4,5-difluoro-1,3-dioxolan-2-one (F₂EC), in a ratio of 1:1. Advantageously, for a binary solvent mixture of 1M LiTFSI in F₁DEC/F₁EC (1:1) no pitting corrosion was observed by a subsequent SEM analysis of the electrochemically studied aluminum foil. In a preferred embodiment of a binary solvent mixture, the electrolyte solution comprises a mixture of ethyl (1-fluoroethyl)carbonate (F₁DEC) or 1-fluoroethyl(2,2,2-trifluoroethyl)carbonate (F₄DEC) and 4-fluoro-1,3-dioxolan-2-one (F₁EC), in a ratio of 1:1. It could be shown that the conductivity of binary mixtures of F₁DEC or F₄DEC with F₁EC were even higher than that of mixtures with F₂EC.

If not indicated otherwise, the ratios of electrolyte solvents or compounds as given refer to a respective weight ratio. Weight percent, abbreviated wt % or wt.-% are synonyms that refer to the concentration of a compound as the weight of the compound divided by the weight of the composition and multiplied by 100. The weight-% (wt.-% or wt %) of the components are calculated based on the total weight amount of the composition, if not otherwise stated. The total amount of all solvents of the solution does not exceed 100 wt.-%.

In further embodiments, the electrolyte solution comprises a ternary solvent mixture of at least one fluorinated acyclic dialkyl carbonate, preferably of at least one n-fluoro diethyl carbonate according to formula (1): C₂H₅₋ₓFₓCO₃C₂H_{5-y}F_{y} wherein 1≦x≦5 and 0≦y≦5, and at least one cyclic fluorinated carbonate selected from the group consisting of 4-fluoro-1,3-dioxolan-2-one, cis-4,5-difluoro-1,3-dioxolan-2-one, trans-4,5-difluoro-1,3-dioxolan-2-one and mixtures thereof. Preferably the linear or acyclic fluorinated carbonate is selected from the group consisting of ethyl (1-fluoroethyl)carbonate, 1-fluoroethyl(2,2,2-trifluoroethyl)carbonate and mixtures thereof. The ternary solvent mixture may either comprise an n-fluoro diethyl carbonate and two different cyclic fluorinated carbonates, or may comprise two linear fluorinated carbonates and one cyclic fluorinated carbonate. Particularly, a mixture of ethyl (1-fluoroethyl)carbonate, 4-fluoro-1,3-dioxolan-2-one, and trans-4,5-difluoro-1,3-dioxolan-2-one proved useful in regard of conductivity, the resulting current and inhibition of corrosion. In preferred embodiments, the electrolyte solution comprises a ternary solvent mixture of ethyl (1-fluoroethyl)carbonate or 1-fluoroethyl(2,2,2-trifluoroethyl)carbonate, 4-fluoro-1,3-dioxolan-2-one, and trans-4,5-difluoro-1,3-dioxolan-2-one in a ratio of 1:1:1. The F₂EC can have a beneficial effect on the resulting current of a ternary mixture. Also in such ternary mixture the aluminum foil did not show any indication of severe pitting corrosion.

Further, it could advantageously be shown that the linear or acyclic fluorinated carbonates according to the invention also are usable for the inhibition of aluminum current collector corrosion in non-fluorinated organic carbonates. This is of particular benefit as non-fluorinated organic carbonates are used as standard solvents in commercial lithium-ion batteries. Hence, another preferred embodiment refers to an electrolyte solution further comprising a non-fluorinated organic carbonate selected from the group consisting of ethylene carbonate, ethyl methyl carbonate, propylene carbonate, dimethyl carbonate, diethyl carbonate and mixtures thereof. It could be shown that the fluorinated acyclic dialkyl carbonates, particularly ethyl (1-fluoroethyl)carbonate (F₁DEC) or 1-fluoroethyl(2,2,2-trifluoroethyl)carbonate (F₄DEC), in a standard electrolyte solvent mixture of ethylene carbonate and dimethyl carbonate in a 1:1 ratio efficiently could prevent an aluminum current collector from anodic aluminum dissolution. Preferably, the electrolyte solution comprises a solvent mixture of ethylene carbonate, dimethyl carbonate and ethyl (1-fluoroethyl)carbonate or 1-fluoroethyl(2,2,2-trifluoroethyl)carbonate in a ratio of 1:1:1.

It was investigated whether for the beneficial effect of the linear fluorinated carbonates already the addition of only little amounts to common organic electrolytes might be sufficient. However, it appeared that its use as simple additive, for example in amount of about 4 wt. %, referring to the total weight of the electrolyte solvent, either in cyclic fluorinated carbonates or in standard non-fluorinated carbonates was not sufficient in order to suppress aluminum current collector corrosion. Further, also an amount of about 11 wt.-% of ethyl (1-fluoroethyl)carbonate (F₁DEC) in cyclic fluorinated or non-fluorinated carbonate-based electrolytes was not sufficient to protect the aluminum current collector from corrosion. An amount of just ≧20 wt.-% of ethyl (1-fluoroethyl)carbonate (F₁DEC) either in cyclic fluorinated carbonates or in standard non-fluorinated carbonates showed a clear improvement in the passivation of an aluminum current collector.

In embodiments, the electrolyte solution comprises the fluorinated acyclic dialkyl carbonate, preferably the n-fluoro diethyl carbonate, in a range of ≧25 wt % to ≦100 wt %, preferably in a range of ≧25 wt % to ≦75 wt %, more preferably in a range of ≧30 wt % to ≦50 wt %, referring to a total amount of the electrolyte solvent of 100 wt %.

Studies using 1 M LiTFSI and cyclic fluorinated solvent mixtures with F₁DEC, for example F₁DEC/F₂EC (1:1), showed that to properly protect the aluminum current collector from anodic aluminum dissolution the electrolyte composition should comprise at least about 20 wt.-%, while improved protection could be achieved using an electrolyte solution comprising about 25 wt.-% and even more preferably about 30 wt.-% of F₁DEC in case fluorinated cyclic carbonates were used as electrolyte solvents. About 33 wt.-% of F₁DEC appeared to be more than sufficient for a proper passivation of the aluminum current collector. Hence, for binary or ternary solvent mixtures with fluorinated cyclic carbonates the electrolyte solution may comprise the n-fluoro diethyl carbonate in a range of ≧20 wt % to ≦50 wt %, preferably range of ≧25 wt % to ≦50 wt %, more preferably in a range of ≧25 wt % to ≦33 wt %, referring to a total amount of the electrolyte solvent of 100 wt %. Using a low amount of linear or acyclic fluorinated carbonates will reduce the total cost for the solvent.

Referring to non-fluorinated carbonate solvents, aluminum passivation within the first cycles by using 25 wt. % of F₁DEC could be achieved. However, a F₁DEC content of around 33 wt.-% appeared preferable with respect to the occurring current within the initial cycles, indicating a more effective aluminum passivation. To properly protect the aluminum current collector from anodic aluminum dissolution the electrolyte composition should comprise at least about 20 wt. %, while improved protection could be achieved using an electrolyte solution comprising about 25 wt. % and even more preferably about 30 wt. % of F₁DEC in case non-fluorinated organic carbonates are used as electrolyte solvents. Hence, for binary or ternary solvent mixtures with non-fluorinated carbonates the electrolyte solution may comprise the n-fluoro diethyl carbonate in a range of ≧20 wt % to ≦50 wt %, preferably in a range of ≧25 wt % to ≦50 wt %, referring to a total amount of the electrolyte solvent of 100 wt %. Particularly referring to mixtures of ethylene carbonate and dimethyl carbonate, in embodiments, the electrolyte solution comprises a mixture of ethylene carbonate and dimethyl carbonate in a ratio of 1:1 and the n-fluoro diethyl carbonate in a range of ≧20 wt % to ≦50 wt %, preferably in the range of ≧25 wt % to ≦50 wt %, referring to a total amount of the electrolyte solvent of 100 wt %.

Another aspect of the invention refers to an alkali or alkaline earth metal-based electrochemical energy storage device, particularly a lithium battery, a lithium-ion battery, a lithium-ion accumulator, a lithium polymer battery or a lithium-ion capacitor, comprising an electrolyte solution according to the invention. Preferably, the electrolyte solution according to the invention is usable for a lithium or lithium-ion battery. A lithium-ion battery for example comprises a first electrode of a cathodic material, a second electrode of an anodic material and an electrolyte.

The term “energy storage device” comprises primary batteries and rechargeable batteries or accumulators. However, colloquially accumulators are also denoted with the term “battery” which usually is used as a generic term. Hence, for simplicity if not denoted otherwise, in the present invention the term “battery” is used synonymous to also designate “accumulators”.

Surprisingly, it was found that the electrolyte compositions are not only usable in combination with common lithium-ion battery cathode materials such as LiFePO₄ (LFP) or LiNi_{1/3}Mn_{1/3}Co_{1/3}O₂ (NMC) but also provide a promising electrolyte solvent for high voltage cathode materials, as for instance LiNi_{0.4}Mn_{1.6}O₄. Advantageously, all electrolyte compositions were stable at least up to 5 V. Further, it could be shown that cells comprising the electrolyte compositions exhibited a high efficiency and high capacity. Particularly, in NMC half cells 1 M LiTFSI in F₁DEC showed slightly higher efficiency than for commercial LP30 cells. Also, the electrochemical performance of NMC in 1 M LiTFSI in binary mixtures of fluorinated carbonates such as F₁DEC/F₁EC (1:1) as well as in ternary mixtures of fluorinated carbonates such as F₁DEC/F₁EC/F₂EC (1:1:1) showed a high efficiency comparable with LP30 cells. Moreover, binary mixtures of linear and cyclic fluorinated carbonates have been confirmed to be also suitable for graphite-based anodes.

Consequently, the electrolyte compositions can be readily used for lithium-ion cells and are sufficiently stable towards oxidation, also in presence of transition metal oxides and phosphates, delivering at least a highly similar specific capacity, cycling stability, and electrochemical performance as observed for commercial available cells.

Particularly, the electrolyte solution comprising an electrolyte salt and an electrolyte solvent, wherein the electrolyte solvent comprises a fluorinated acyclic dialkyl carbonate, preferably an n-fluoro diethyl carbonate according to formula (1) as follows: C₂H₅₋ₓFₓCO₃C₂H_{5-y}F_{y} (1) wherein 1≦x≦5 and 0≦y≦5, in an amount in the range of ≧10 wt % to ≦100 wt %, preferably in the range of ≧20 wt % to ≦100 wt %, referring to a total amount of the electrolyte solvent of 100 wt %, is usable for alkali or alkaline earth metal-based batteries containing an electrolyte solution comprising a sulfonimide electrolyte salt and using an aluminum current collector.

The electrolyte salt can be an alkali or alkaline earth metal sulfonimide or sulfonmethide salt. The sulfonimide salt preferably is selected from lithium, sodium, potassium, magnesium, or calcium metal sulfonimide salts. Preferably, the sulfonimide salt is a lithium salt selected from the group consisting of lithium bis(trifluoromethanesulfonyl)imide LiN(SO₂CF₃)₂ (LiTFSI), lithium bis(fluorosulfonyl)imide (LiFSI), LiN(FSO₂)₂, lithium trifluoromethanesulfonate Li(CF₃)SO₃ (LiTf), lithium (trifluoromethylsulfonyl)(nonafluorobutanesulfonyl)imide LiN(SO₂CF₃)(SO₂C₄F₉), lithium (fluorosulfonyl)(nonafluorobutanesulfonyl)imide LiN(SO₂F)(SO₂C₄F₉), lithium (nonafluoro butan-2-one sulfonyl)(trifluoromethylsulfonyl)imide LiN(SO₂C₂F₄OC₂F₅)(SO₂CF₃), and lithium(nonafluoro butan-2-one sulfonyl)(fluorosulfonyl)imide LiN(SO₂C₂F₄OC₂F₅)(SO₂F). Preferred lithium sulfonimide salts are bis(trifluoromethanesulfonyl)imide LiN(SO₂CF₃)₂ (LiTFSI), lithium bis(fluorosulfonyl)imide (LiFSI), and lithium trifluoromethanesulfonate Li(CF₃)SO₃ (LiTf). The sulfonmethide salt preferably is LiC(CF₃SO₂)₃.

The fluorinated diethyl carbonate at each ethyl group may comprise one, two, three or more fluoro substituents and/or at least a 1-fluoroethyl group, a 2-fluoroethyl group, a 2,2,2-trifluoroethyl group or a pentafluoroethyl group. Hence, in formula (1) x may be an integer of 1, 2, 3, 4 or 5, while y may be an integer of 0, 1, 2, 3, 4 or 5. The n-fluoro diethyl carbonate can be selected from the group consisting of ethyl (1-fluoroethyl)carbonate, 1-fluoroethyl(2,2,2-trifluoroethyl)carbonate, bis(2-fluoroethyl)carbonate, bis(2,2,2-trifluoroethyl)carbonate, bis(1,2,2-trifluoroethyl)carbonate and mixtures thereof. Preferably, the n-fluoro diethyl carbonate is selected from the group consisting of ethyl (1-fluoroethyl)carbonate, 1-fluoroethyl(2,2,2-trifluoroethyl)carbonate and mixtures thereof. The electrolyte solvent further can comprises at least one cyclic fluorinated carbonate selected from the group consisting of 4-fluoro-1,3-dioxolan-2-one, 4,5-difluoro-1,3-dioxolan-2-one particularly cis-4,5-difluoro-1,3-dioxolan-2-one or trans-4,5-difluoro-1,3-dioxolan-2-one, and mixtures thereof.

The electrolyte solution may comprise at least one cyclic fluorinated carbonate selected from the group consisting of 4-fluoro-1,3-dioxolan-2-one, 4,5-difluoro-1,3,dioxolane-2-one, particularly cis-4,5-difluoro-1,3,dioxolane-2-one or trans-4,5-difluoro-1,3,dioxolane-2-one.

The electrolyte solution may comprise a binary solvent mixture of a fluorinated acyclic dialkyl carbonate, preferably an n-fluoro diethyl carbonate according to formula C₂H₅₋ₓFₓCO₃C₂H_{5-y}F_{y} (1) wherein 1≦x≦5 and 0≦y≦5, and a cyclic fluorinated carbonate selected from the group consisting of 4-fluoro-1,3-dioxolan-2-one (F₁EC), cis-4,5-difluoro-1,3-dioxolan-2-one, and trans-4,5-difluoro-1,3-dioxolan-2-one. Preferably, the electrolyte solution may comprise a binary solvent mixture of ethyl (1-fluoroethyl)carbonate or 1-fluoroethyl(2,2,2-trifluoroethyl)carbonate and a cyclic fluorinated carbonate selected from the group consisting of 4-fluoro-1,3-dioxolan-2-one, cis-4,5-difluoro-1,3-dioxolan-2-one, and trans-4,5-difluoro-1,3-dioxolan-2-one. It could be shown that the conductivity of binary solvent mixtures was higher than that of the linear carbonates alone. The binary solvent mixture may comprise a mixture of ethyl (1-fluoroethyl)carbonate or 1-fluoroethyl(2,2,2-trifluoroethyl)carbonate and 4,5-difluoro-1,3-dioxolan-2-one, particularly trans-4,5-difluoro-1,3-dioxolan-2-one (F₂EC), in a ratio of 1:1. In a preferred embodiment of a binary solvent mixture, the electrolyte solution comprises a mixture of ethyl (1-fluoroethyl)carbonate (F₁DEC) or 1-fluoroethyl(2,2,2-trifluoroethyl)carbonate (F₄DEC) and 4-fluoro-1,3-dioxolan-2-one (F₁EC), in a ratio of 1:1.

Further, the electrolyte solution may comprise a ternary solvent mixture of at least one fluorinated acyclic dialkyl carbonate, preferably of at least one n-fluoro diethyl carbonate according to formula (1): C₂H₅₋ₓFₓCO₃C₂H_{5-y}F_{y} wherein 1≦x≦5 and 0≦y≦5, and at least one cyclic fluorinated carbonate selected from the group consisting of 4-fluoro-1,3-dioxolan-2-one, cis-4,5-difluoro-1,3-dioxolan-2-one, trans-4,5-difluoro-1,3-dioxolan-2-one and mixtures thereof.

Preferably, the linear fluorinated carbonate is selected from the group consisting of ethyl (1-fluoroethyl)carbonate, 1-fluoroethyl(2,2,2-trifluoroethyl)carbonate and mixtures thereof. A ternary solvent mixture may either comprise an n-fluoro diethyl carbonate and two different cyclic fluorinated carbonates, or may comprise two linear fluorinated carbonates and one cyclic fluorinated carbonate. Particularly, a mixture of ethyl (1-fluoroethyl)carbonate, 4-fluoro-1,3-dioxolan-2-one, and trans-4,5-difluoro-1,3-dioxolan-2-one proved useful in regard of conductivity, the resulting current and inhibition of corrosion. The electrolyte solution may comprise a ternary solvent mixture of ethyl (1-fluoroethyl)carbonate or 1-fluoroethyl(2,2,2-trifluoroethyl)carbonate, 4-fluoro-1,3-dioxolan-2-one, and trans-4,5-difluoro-1,3-dioxolan-2-one in a ratio of 1:1:1.

The electrolyte solution may comprise the fluorinated acyclic dialkyl carbonate, preferably the n-fluoro diethyl carbonate, in a range of ≧25 wt % to ≦100 wt %, preferably in a range of ≧25 wt % to ≦75 wt %, more preferably in a range of ≧30 wt % to ≦50 wt %, referring to a total amount of the electrolyte solvent of 100 wt %.

For binary or ternary solvent mixtures with fluorinated cyclic carbonates the electrolyte solution may comprise the fluorinated acyclic dialkyl carbonate, preferably the n-fluoro diethyl carbonate, in a range of ≧20 wt % to ≦50 wt %, preferably range of ≧25 wt % to ≦50 wt %, more preferably in a range of ≧25 wt % to ≦33 wt %, referring to a total amount of the electrolyte solvent of 100 wt %.

The electrolyte solution further may comprise a non-fluorinated organic carbonate selected from the group consisting of ethylene carbonate, ethyl methyl carbonate, propylene carbonate, dimethyl carbonate, diethyl carbonate and mixtures thereof. For binary or ternary solvent mixtures with non-fluorinated carbonates the electrolyte solution may comprise fluorinated acyclic dialkyl carbonate, preferably the n-fluoro diethyl carbonate, in a range of ≧20 wt % to ≦50 wt %, preferably in a range of ≧25 wt % to ≦50 wt %, more preferably in a range of ≧25 wt % to ≦33 wt %, referring to a total amount of the electrolyte solvent of 100 wt %. Particularly referring to mixtures of ethylene carbonate and dimethyl carbonate, in embodiments, the electrolyte solution comprises a mixture of ethylene carbonate and dimethyl carbonate in a ratio of 1:1 and the n-fluoro diethyl carbonate in a range of ≧20 wt % to ≦50 wt %, preferably in the range of ≧25 wt % to ≦50 wt %, referring to a total amount of the electrolyte solvent of 100 wt %.

Another aspect of the invention refers to the use of a fluorinated acyclic dialkyl carbonate, preferably an n-fluoro diethyl carbonate according to formula (1) as follows: C₂H₅₋ₓFₓCO₃C₂H_{5-y}F_{y} (1) wherein 1≦x≦5 and 0≦y≦5, in an amount in the range of ≧10 wt % to ≦100 wt %, preferably in the range of ≧10 wt % to ≦100 wt %, referring to a total amount of an electrolyte solvent of 100 wt %, for the suppresion or prevention of aluminum current collector corrosion in an alkali or alkaline earth metal-based electrochemical energy storage device, particularly a lithium-ion battery or lithium polymer battery containing an electrolyte solution comprising an alkali or alkaline earth metal sulfonimide or sulfonmethide salt.

The alkali or alkaline earth metal sulfonimide salt in preferred embodiments is selected from lithium, sodium, potassium, magnesium, or calcium metal sulfonimide salts. Preferably the sulfonimide salt is a lithium salt selected from the group consisting of lithium bis(trifluoromethanesulfonyl)imide LiN(SO₂CF₃)₂ (LiTFSI), lithium bis(fluorosulfonyl)imide (LiFSI), LiN(FSO₂)₂, lithium trifluoromethanesulfonate Li(CF₃)SO₃ (LiTf), lithium (trifluoromethylsulfonyl)(nonafluorobutanesulfonyl)imide LiN(SO₂CF₃)(SO₂C₄F₉), lithium (fluorosulfonyl)(nonafluorobutanesulfonyl)imide LiN(SO₂F)(SO₂C₄F₉), lithium (nonafluoro butan-2-one sulfonyl)(trifluoromethylsulfonyl)imide LiN(SO₂C₂F₄OC₂F₅)(SO₂CF₃), and lithium(nonafluoro butan-2-one sulfonyl)(fluorosulfonyl)imide LiN(SO₂C₂F₄OC₂F₅)(SO₂F). Preferred lithium sulfonimide salts are bis(trifluoromethanesulfonyl)imide LiN(SO₂CF₃)₂ (LiTFSI), lithium bis(fluorosulfonyl)imide (LiFSI), lithium trifluoromethanesulfonate Li(CF₃)SO₃ (LiTf) and mixtures thereof. The sulfonmethide salt preferably is LiC(CF₃SO₂)₃.

The n-fluoro diethyl carbonate at each ethyl group may comprise one, two, three or more fluoro substituents and/or at least a 1-fluoroethyl group, a 2-fluoroethyl group, a 2,2,2-trifluoroethyl group or a pentafluoroethyl group. Hence, in formula (1) x may be an integer of 1, 2, 3, 4 or 5, while y may be an integer of 0, 1, 2, 3, 4 or 5. The n-fluoro diethyl carbonate can be selected from the group consisting of ethyl (1-fluoroethyl)carbonate, 1-fluoroethyl(2,2,2-trifluoroethyl)carbonate, bis(2-fluoroethyl)carbonate, bis(2,2,2-trifluoroethyl)carbonate, bis(1,2,2-trifluoroethyl)carbonate and mixtures thereof. Preferably the n-fluoro diethyl carbonate is selected from the group consisting of ethyl (1-fluoroethyl)carbonate, 1-fluoroethyl(2,2,2-trifluoroethyl)carbonate and mixtures thereof.

In an embodiment of the use, the fluorinated acyclic dialkyl carbonate is selected from the group consisting of a dimethyl carbonate, an ethyl methyl carbonate, a methyl propyl carbonate, an ethyl propyl carbonate, a dipropyl carbonate or mixtures thereof, preferably the fluorinated dialkyl carbonate is selected from the group consisting of fluoromethyl methyl carbonate, bis(fluoromethyl)carbonate, fluoromethyl ethyl carbonate, fluoromethyl n-propyl carbonate, fluoromethyl isopropyl carbonate, 1-fluoroethyl methyl carbonate, 2-fluoroethyl methyl carbonate, 2,2,2-trifluoroethyl methyl carbonate, 2,2,2-trifluoroethyl fluoromethyl carbonate, 2,2-difluoroethyl methyl carbonate, and 2,2-difluoroethyl fluoromethyl carbonate.

In an embodiment of the use, the electrolyte solvent further comprises at least one cyclic fluorinated carbonate selected from the group consisting of 4-fluoro-1,3-dioxolan-2-one, 4,5-difluoro-1,3-dioxolan-2-one particularly cis-4,5-difluoro-1,3-dioxolan-2-one or trans-4,5-difluoro-1,3-dioxolan-2-one and mixtures thereof, and/or a non-fluorinated organic carbonate selected from the group consisting of ethylene carbonate, ethyl methyl carbonate, propylene carbonate, dimethyl carbonate, diethyl carbonate and mixtures thereof.

The electrolyte solvent further can comprises at least one cyclic fluorinated carbonate selected from the group consisting of 4-fluoro-1,3-dioxolan-2-one, cis-4,5-difluoro-1,3-dioxolan-2-one, trans-4,5-difluoro-1,3-dioxolan-2-one, and mixtures thereof.

The electrolyte solution can comprise a binary solvent mixture of an n-fluoro diethyl carbonate according to formula C₂H₅₋ₓFₓCO₃C₂H_{5-y}F_{y} (1) wherein 1≦x≦5 and 0≦y≦5 and a cyclic fluorinated carbonate selected from the group consisting of 4-fluoro-1,3-dioxolan-2-one (F₁EC), cis-4,5-difluoro-1,3-dioxolan-2-one, and trans-4,5-difluoro-1,3-dioxolan-2-one. Preferably, the electrolyte solution may comprises a binary solvent mixture of ethyl (1-fluoroethyl)carbonate or 1-fluoroethyl(2,2,2-trifluoroethyl)carbonate and a cyclic fluorinated carbonate selected from the group consisting of 4-fluoro-1,3-dioxolan-2-one, cis-4,5-difluoro-1,3-dioxolan-2-one, and trans-4,5-difluoro-1,3-dioxolan-2-one. It could be shown that the conductivity of binary solvent mixtures was higher than that of the linear carbonates alone. The binary solvent mixture may comprise a mixture of ethyl (1-fluoroethyl)carbonate or 1-fluoroethyl(2,2,2-trifluoroethyl)carbonate and 4,5-difluoro-1,3-dioxolan-2-one, particularly trans-4,5-difluoro-1,3-dioxolan-2-one (F₂EC), in a ratio of 1:1. In a preferred embodiment of a binary solvent mixture, the electrolyte solution comprises a mixture of ethyl (1-fluoroethyl)carbonate (F₁DEC) or 1-fluoroethyl(2,2,2-trifluoroethyl)carbonate (F₄DEC) and 4-fluoro-1,3-dioxolan-2-one (F₁EC), in a ratio of 1:1.

Further, the electrolyte solution can comprises a ternary solvent mixture of at least one n-fluoro diethyl carbonate according to formula (1): C₂H₅₋ₓFₓCO₃C₂H_{5-y}F_{y} wherein 1≦x≦5 and 0≦y≦5, and at least one cyclic fluorinated carbonate selected from the group consisting of 4-fluoro-1,3-dioxolan-2-one, cis-4,5-difluoro-1,3-dioxolan-2-one, trans-4,5-difluoro-1,3-dioxolan-2-one and mixtures thereof.

Preferably, the linear fluorinated carbonate is selected from the group consisting of ethyl (1-fluoroethyl)carbonate, 1-fluoroethyl(2,2,2-trifluoroethyl)carbonate and mixtures thereof. An ternary solvent mixture may either comprise an n-fluoro diethyl carbonate and two different cyclic fluorinated carbonates, or may comprise two linear fluorinated carbonates and one cyclic fluorinated carbonate. Particularly, a mixture of ethyl (1-fluoroethyl)carbonate, 4-fluoro-1,3-dioxolan-2-one, and trans-4,5-difluoro-1,3-dioxolan-2-one proved useful in regard of conductivity, the resulting current and inhibition of corrosion. The electrolyte solution may comprise a ternary solvent mixture of ethyl (1-fluoroethyl)carbonate or 1-fluoroethyl(2,2,2-trifluoroethyl)carbonate, 4-fluoro-1,3-dioxolan-2-one, and trans-4,5-difluoro-1,3-dioxolan-2-one in a ratio of 1:1:1.

The electrolyte solution may comprise the n-fluoro diethyl carbonate in a range of ≧25 wt % to ≦100 wt %, preferably in a range of ≧25 wt % to ≦75 wt %, more preferably in a range of ≧30 wt % to ≦50 wt %, referring to a total amount of the electrolyte solvent of 100 wt %.

For binary or ternary solvent mixtures with fluorinated cyclic carbonates the electrolyte solution may comprise the n-fluoro diethyl carbonate in a range of ≧20 wt % to ≦50 wt %, preferably range of ≧25 wt % to ≦50 wt %, more preferably in a range of ≧25 wt % to ≦33 wt %, referring to a total amount of the electrolyte solvent of 100 wt %.

The electrolyte solution further may comprise a non-fluorinated organic carbonate selected from the group consisting of ethylene carbonate, ethyl methyl carbonate, propylene carbonate, dimethyl carbonate, diethyl carbonate and mixtures thereof. For binary or ternary solvent mixtures with non-fluorinated carbonates the electrolyte solution may comprise the fluorinated acyclic dialkyl carbonate, preferably the n-fluoro diethyl carbonate, in a range of ≧20 wt % to ≦50 wt %, preferably in a range of ≧25 wt % to ≦50 wt %, more preferably in a range of ≧25 wt % to ≦33 wt %, referring to a total amount of the electrolyte solvent of 100 wt %. Particularly referring to mixtures of ethylene carbonate and dimethyl carbonate, in embodiments, the electrolyte solution comprises a mixture of ethylene carbonate and dimethyl carbonate in a ratio of 1:1 and the n-fluoro diethyl carbonate in a range of ≧20 wt % to ≦50 wt %, preferably in the range of ≧25 wt % to ≦50 wt %, referring to a total amount of the electrolyte solvent of 100 wt %.

Another aspect of the invention concerns an aluminium current collector comprising a modified surface wherein the modified surface is obtained or is obtainable by contacting the aluminium current collector with a electrolyte solution comprising an electrolyte salt and an electrolyte solvent, wherein the electrolyte solvent comprises a fluorinated acyclic dialkyl carbonate, preferably an n-fluoro diethyl carbonate according to formula (1) as follows: C₂H₅₋ₓFₓCO₃C₂H_{5-y}F_{y} (1) wherein 1≦x≦5 and 0≦y≦5. Also preferably, the modified surface is obtained or is obtainable by contacting aluminium current collector with a electrolyte solution comprising an electrolyte salt and an electrolyte solvent, wherein the electrolyte salt is selected from the preferred alkali or alkaline earth metal sulfonimide salts as described above. Also preferably, the aluminium current collector is comprised in a lithium ion battery and the modified surface is obtained during at least one charge and/or discharge process of the lithium ion battery, preferably by contacting the aluminium current collector with an electrolyte solution comprising an electrolyte salt selected from at least one of the preferred alkali or alkaline earth metal sulfonimide salts as described above and an electrolyte solvent comprising a fluorinated acyclic dialkyl carbonate.

Unless otherwise defined, the technical and scientific terms used herein have the same meaning as commonly understood by one of ordinary skill in the art to which this invention belongs.

The examples which follow serve to illustrate the invention in more detail but do not constitute a limitation thereof.

In the figures show:

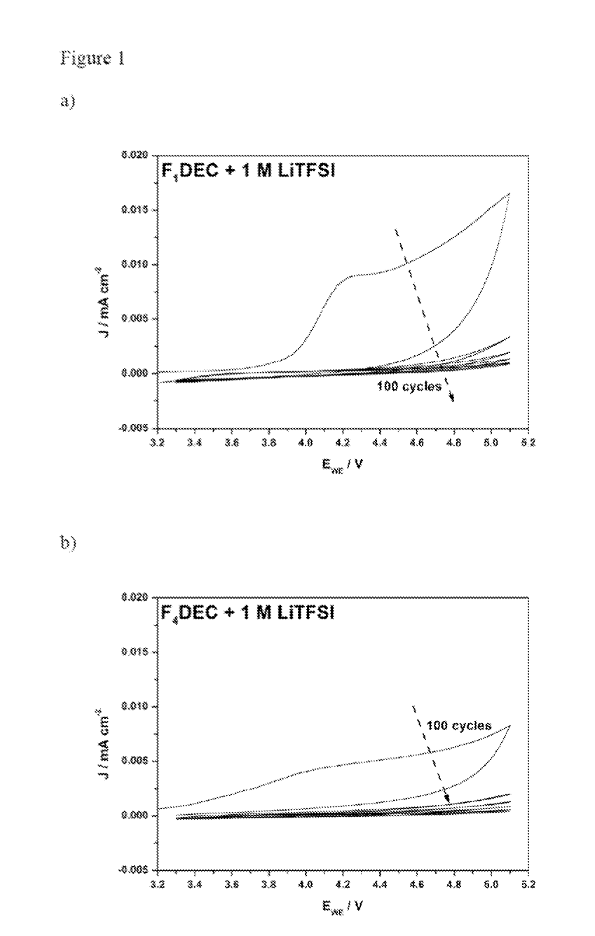

FIG. 1 Cyclovoltammograms of fluorinated linear carbonates as only solvents for a 1 M solution of LiTFSI. FIG. 1a) shows the cyclovoltammogram for F₁DEC, and FIG. 1b) for F₄DEC for 100 cycles using aluminum as working electrode.

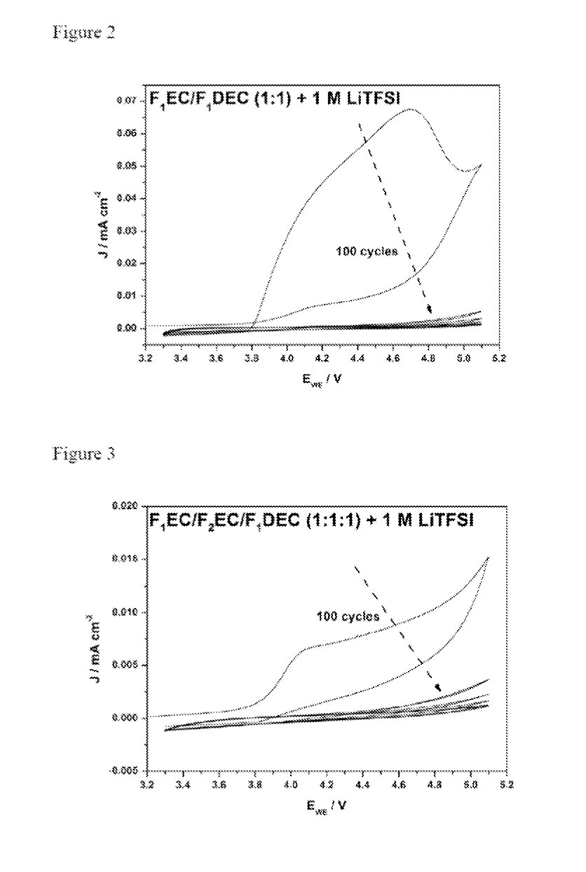

FIG. 2 the cyclovoltammogram of 1 M LiTFSI in a binary mixture of F₁DEC and F₁EC in a ratio of 1:1 for 100 cycles using aluminum as working electrode.

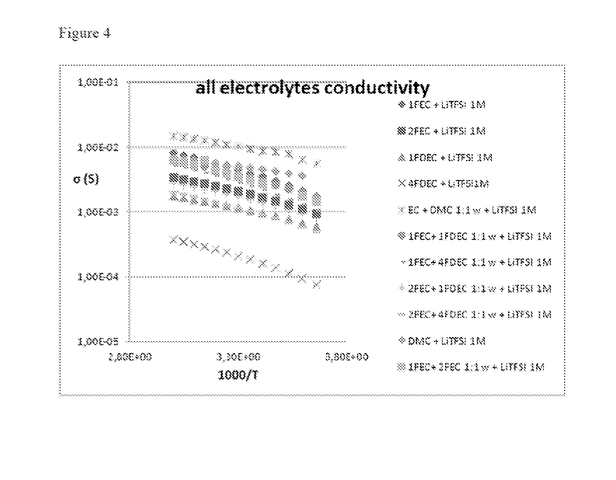

FIG. 3 the cyclovoltammogram of 1 M LiTFSI in a ternary mixture of F₁DEC, F₁EC and F₂EC in a ratio of 1:1:1 for 100 cycles using aluminum as working electrode.

FIG. 4 Ionic conductivities of 1 M LiTFSI in linear fluorinated carbonates and binary solvent mixtures of linear and cyclic fluorinated carbonates.

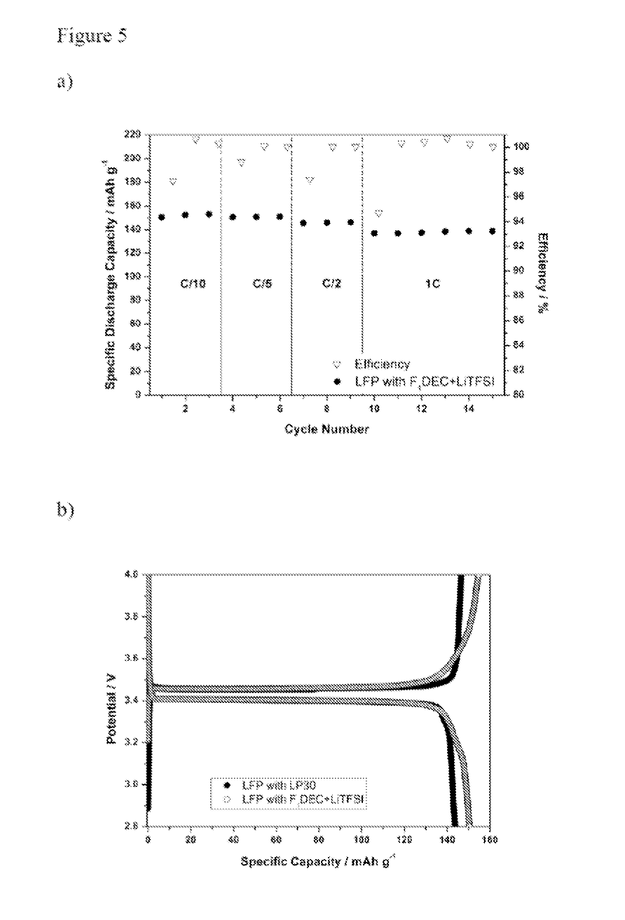

FIG. 5 the electrochemical performance of a carbon coated LiFePO₄ (LFP) electrode in a solution of 1 M LiTFSI in F₁DEC. FIG. 5a) shows the galvanostatic cycling of the Li/LiFePO₄ half cell with Li as reference electrode. Cut-off potentials were at 2.8-4.0 V. Plotted is the specific discharge capacity (left ordinate) against the efficiency (right ordinate) against the cycle number. FIG. 5b) shows the potential profile comparison of Li/LiFePO₄ half cell with Li as reference electrode with 1 M LiPF₆ in EC/DMC (1:1) (LP30) as electrolyte; Cut-offs: 2.8-4.0 V; 1st cycle (C/10). A C rate of 1C corresponds to an applied specific current of 170 mA g⁻¹, allowing a full charge or discharge of the electrode within one hour.

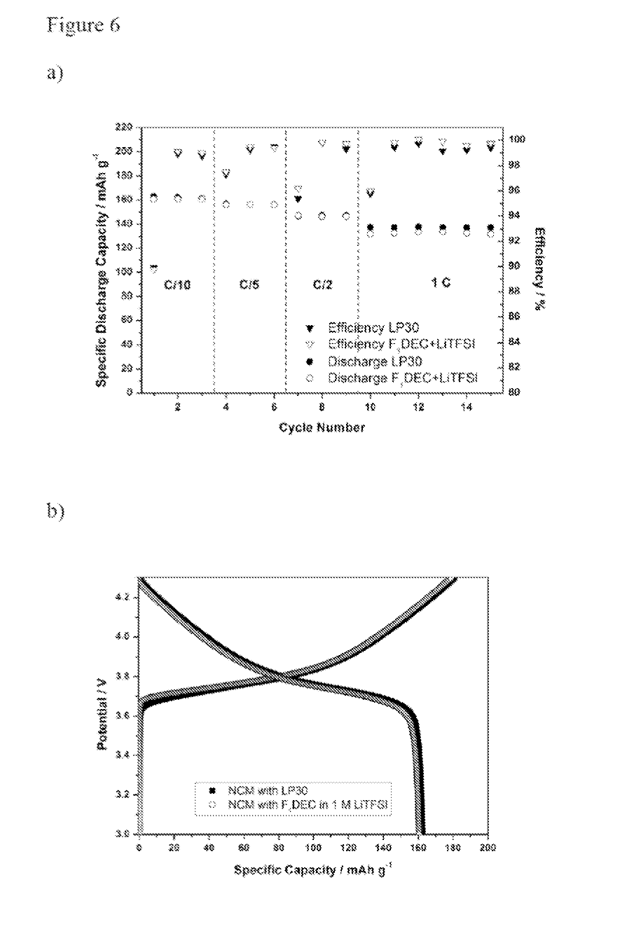

FIG. 6 the electrochemical performance of a LiNi_{1/3}Mn_{1/3}Co_{1/3}O₂ (NMC) half cell in a solution of 1 M LiTFSI in F₁DEC. FIG. 6a) shows the galvanostatic cycling comparison of the Li/LiNi_{1/3}Mn_{1/3}Co_{1/3}O₂ half cell with Li as reference electrode and 1 M LiPF₆ in EC/DMC (1:1) (LP30) as electrolyte; Cut-offs: 3.0-4.3 V. FIG. 6b) shows the potential profile comparison of Li/LiNi_{1/3}Mn_{1/3}Co_{1/3}O₂ half cell with Li as reference electrode with 1 M LiTFSI in F₁DEC and 1 M LiPF₆ in EC/DMC (1:1) (LP30) as electrolyte; Cut-offs: 2.8-4.0 V; 1st cycle (C/10). A C rate of 1C corresponds to an applied specific current of 160 mA g⁻¹, allowing a full charge or discharge of the electrode within one hour.

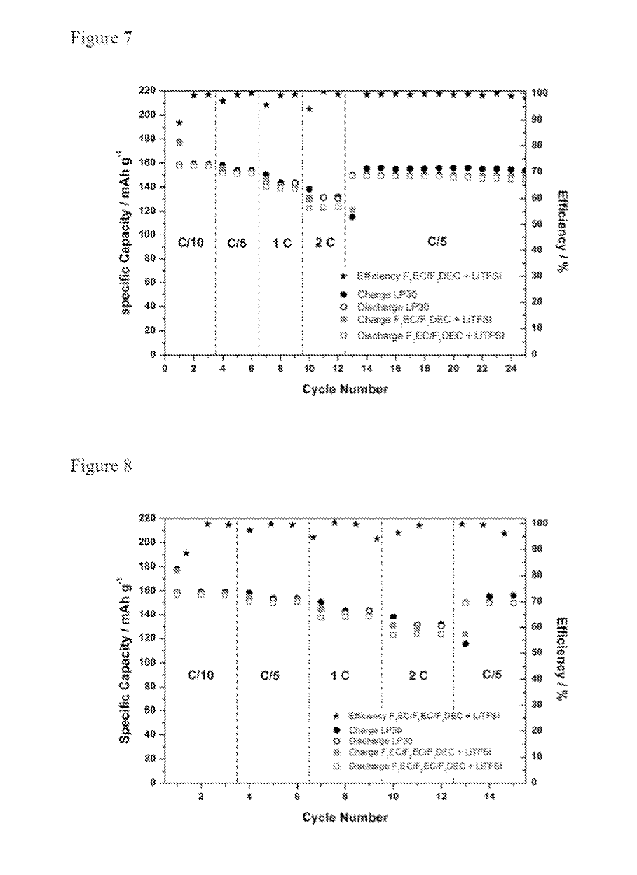

FIG. 7 a galvanostatic cycling comparison of a Li/LiNi_{1/3}Mn_{1/3}Co_{1/3}O₂ (NMC) half cell with Li as reference electrode with 1 M LiTFSI in a binary mixture of F₁EC/F₁DEC (1:1) and 1 M LiPF₆ in EC/DMC (1:1) (LP30) as electrolyte; Cut-offs: 3.0-4.3 V.

FIG. 8 a galvanostatic cycling comparison of a Li/LiNi_{1/3}Mn_{1/3}Co_{1/3}O₂ (NMC) half cell with Li as reference electrode with 1 M LiTFSI in a ternary mixture of F₁EC/F₂EC/F₁DEC (1:1:1) and 1 M LiPF₆ in EC/DMC (1:1) (LP30) as electrolyte; Cut-offs: 3.0-4.3 V.

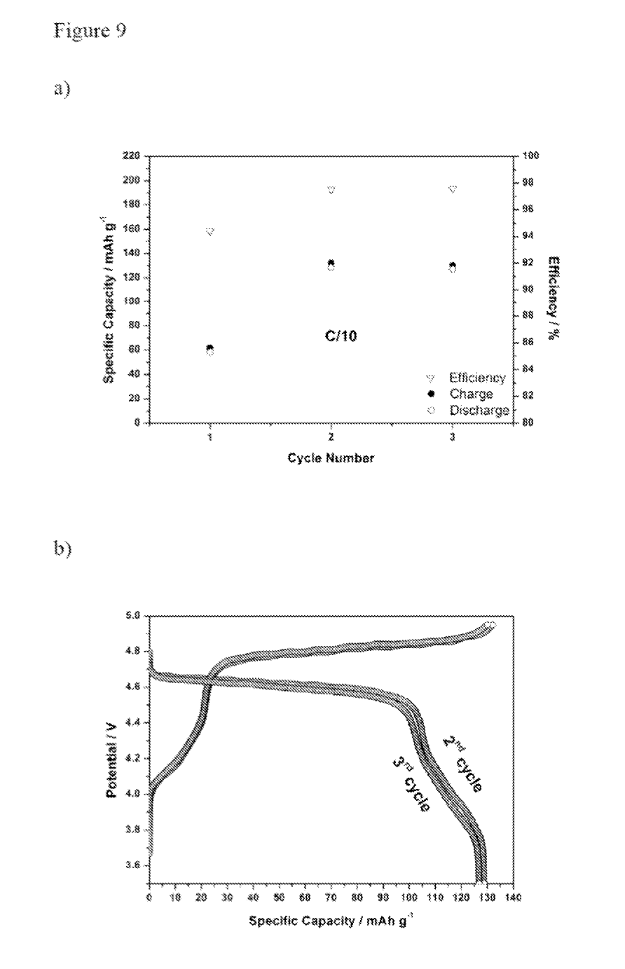

FIG. 9 the electrochemical performance of a LiNi_{0.4}Mn_{1.6}O₄ (LNMO) half cell in a solution of 1 M LiTFSI in F₄DEC. FIG. 9a) shows the galvanostatic cycling of Li/LiNi_{0.4}Mn_{1.6}O₄ half cell with Li as reference electrode; Cut-offs: 3.5-4.95 V. FIG. 9b) shows selected potential profiles of the Li/LiNi_{0.4}Mn_{1.6}O₄ half cell; Cut-offs: 3.5-4.95 V; 2nd (C/10) and 3rd (C/10) cycle. A C rate of 1C corresponds to an applied specific current of around 147 mA g⁻¹, allowing a full charge or discharge of the electrode within one hour.

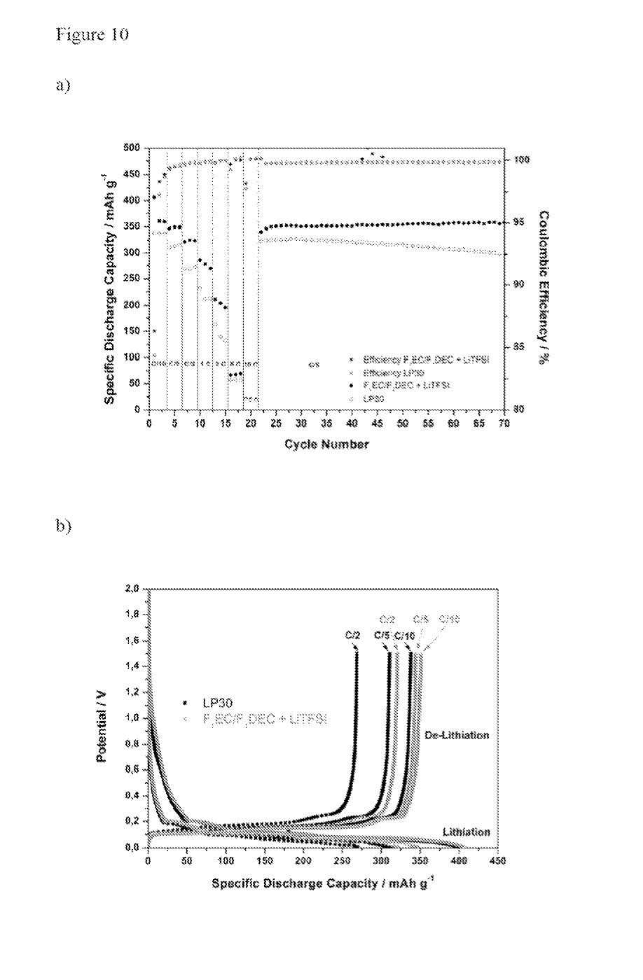

FIG. 10 the electrochemical performance of a graphite (SLP30) half cell in a binary mixture of 1 M LiTFSI in F₁DEC and F₁EC in a ratio of 1:1. FIG. 10a) shows the galvanostatic cycling comparison of graphite (SLP30) half cell with Li as reference electrode with 1 M LiTFSI in F₁EC/F₁DEC (1:1) and of 1 M LiPF₆ in EC/DMC (1:1) (LP30) as electrolyte; Cut-offs: 0.02-1.5 V. FIG. 10b) shows selected potential profiles of the graphite (SLP30) half cell at different C rates (C/10, C/5, C/2) in comparison for the two electrolytes. A C rate of 1C corresponds to an applied specific current of 372 mA allowing a full charge or discharge of the electrode within one hour.

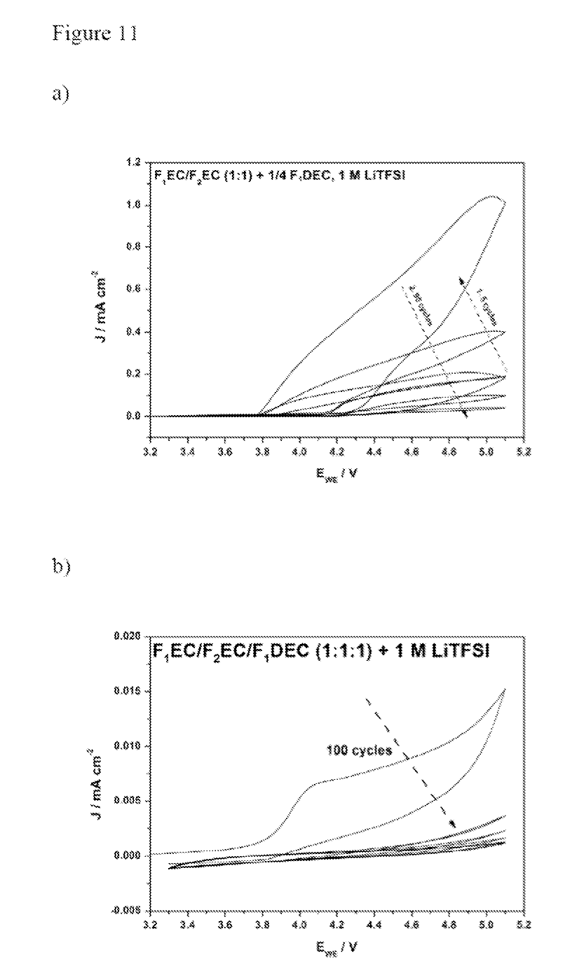

FIG. 11 Cyclovoltammograms for different concentrations of linear fluorinated carbonates with cyclic fluorinated carbonates as solvent for a 1 M solution of LiTFSI. FIG. 11a) shows the cyclovoltammogram for a mixture of 20 wt % of 20 wt % of F₁DEC in F₁EC and F₂EC in a weight ratio of 1:1, and FIG. 11b) for 33 wt % of F₁DEC in F₁EC and F₂EC in a weight ratio of 1:1, each for 100 cycles using aluminum as working electrode.

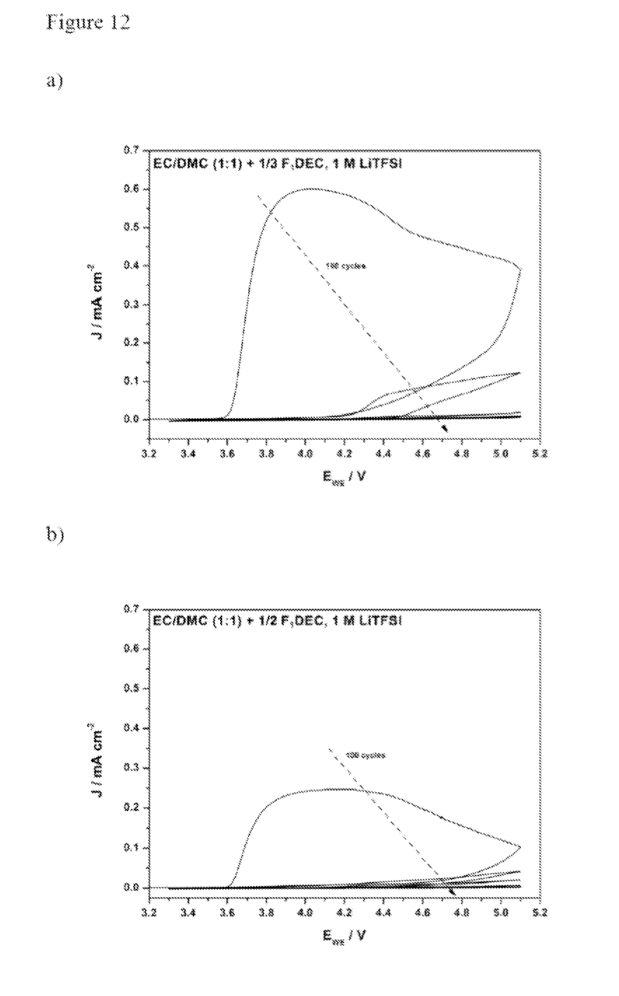

FIG. 12 Cyclovoltammograms for different concentrations of linear fluorinated carbonates with non-fluorinated carbonates as solvent for a 1 M solution of LiTFSI. FIG. 12a) shows the cyclovoltammogram for a mixture of 25 wt % of F₁DEC and FIG. 12b) for 33 wt % of F₁DEC in EC/DMC in a ratio of 1:1, each for 100 cycles using aluminum as working electrode.

FIG. 13 the determination of the electrochemical stability window (ESW) of fluorinated and non-fluorinated organic carbonate solvents with 1 M LiTFSI as conductive salt; the working electrode was a Platinum-wire with lithium metal foils as counter and reference electrodes; oxidative current limit: 0.01 mA.

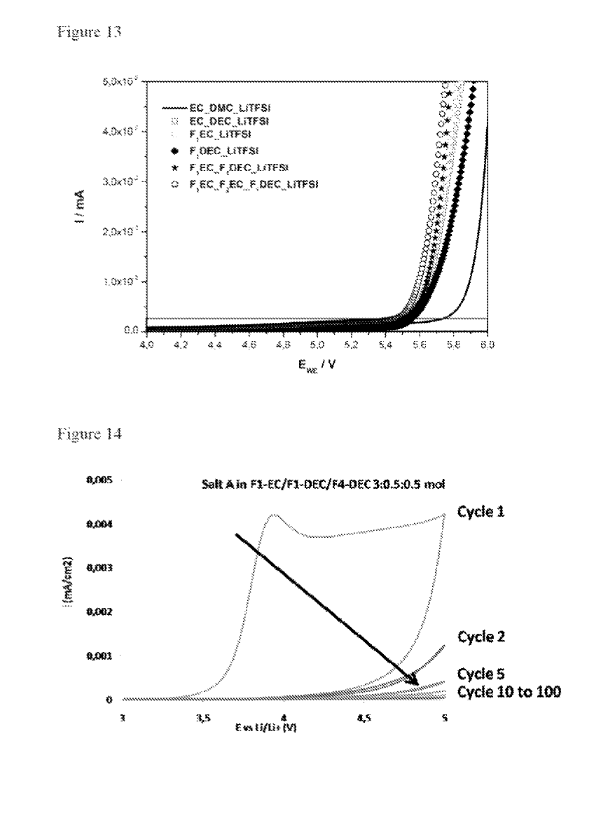

FIG. 14 the cyclovoltammogram of 1 M lithium(nonafluoro butan-2-one sulfonyl)(trifluoro-methylsulfonyl)imide (salt A) in a ternary mixture of F₁EC/F₁DEC/F3DEC in a mol ratio of 3:0.5:0.5 for 100 cycles using aluminum as working electrode; scan rate: 2 mV sec⁻¹.

### ELECTRODE PREPARATION

NMC-based electrodes were prepared using commercial NMC powder (Toda), which was mixed with PVdF binder (5130, Solvay) and LITX™ 200 conductive carbon (Cabot Corporation) in a weight ratio of 94:3:3 using NMP as solvent. The obtained electrode paste was coated on battery grade aluminum foil using a laboratory doctor blade technique. Subsequently, electrodes were punched having a diameter of 12 mm. After drying at 120° C. under vacuum over night, such electrodes had an average mass loading of around 11 mg cm⁻².

LFP-based electrodes were prepared by mixing commercial LFP powder (Südchemie) with PVdF 5130 and LITX™ 200 conductive carbon in a weight ratio of 91:6:4 using NMP as solvent. After drying accordingly to the NMC-based electrodes, such electrode disks (ø=12 mm) had an average mass loading of around 9.5 mg cm².

LNMO-based electrodes were prepared according to the previous description, having an overall composition of 85:5:10 (LNMO:PVdF:Super C65 conductive carbon, TIMCAL) and an average mass loading of around 10 mg cm⁻².

Graphite-based electrodes were prepared using commercial graphite powder (SLP30, TIMCAL), PVdF (Polyvinylidene fluoride) binder (9200, Solvay), and Super C65 conductive carbon, having an overall weight ratio of 91:6:3. Copper foil (battery grade, EVONIK) served as current collector. Punched and dried electrodes had an average mass loading of 4-5 mg cm⁻².

### Electrochemical Characterization

Electrochemical studies were performed utilizing three-electrode, Swagelok™-type cells. Lithium metal foil (Rockwood Lithium, battery grade) served as reference and counter electrode, if not otherwise specified. The cells were assembled in an MBraun glove box with oxygen and water contents below 0.5 ppm. A sheet of Whatman GF/D glass fiber drenched with the respective electrolyte solutions served as separator. All electrochemical studies were performed at 20° C.±2° C. Cyclic voltammetry experiments were performed by means of a VMP3 potentiostat (BioLogic). Galvanostatic cycling of NMC, LFP, and Graphite-based electrodes was carried out using a Maccor Battery Tester 4300. Since lithium foil was used as counter and reference electrode, all the potentials as given refer to the Li⁺/Li reference.

For the investigation of the anodic aluminum dissolution (“corrosion”) in various electrolyte compositions blank aluminum foil (battery grade, 99.99% purity, EVONIK) were utilized as working electrode.

### SEM Analysis

Ex situ scanning electron microscope (SEM) analysis of aluminum current collectors (EVONIK, 20 μm, purity >99.9%) was carried out on a ZEISS Auriga® microscope.

### Solvents and Lithium Salts

Ethylene carbonate (EC), diethyl carbonate (DEC), and dimethyl carbonate (DMC), all battery grade, were purchased at UBE Corporation and Ferro Corporation. Readily prepared EC:DMC (1:1) 1M LiPF₆ electrolyte (LP30) was purchased at Merck KGaA.

Ethyl (1-fluoroethyl)carbonate (F₁DEC), battery grade, was prepared as described in WO 2011/006822.

Preparation of 1-fluoroethyl 2,2,2-trifluoroethyl carbonate (F₄DEC):

1-Fluoroethyl fluoroformate (prepared according to the procedure as described in WO 2011/006822, 1063 g, 9 mol) was placed in a 2000 mL PFA-reactor. After cooling to 3° C., a mixture of pyridine (240 g, 3 mol) and 2,2,2-trilfuoroethanol (916 g, 9 mol) was added over a period of 90 minutes while the liquid phase temperature was kept below 50° C. After stirring at 3° C. for an additional 22 h, the mixture was washed with citric acid solution (30% in water) twice (350 g, 100 g). After drying with molecular sieves (4 Å), the material was further purified by distillation under reduced pressure to battery grade.

LiPF₆, lithium bis(trifluoromethanesulfonyl)imide LiN(SO₂CF₃)₂ (LiTFSI), and lithium(nonafluoro butan-2-one sulfonyl)(trifluoromethylsulfonyl)imide, all battery grade, were purchased at 3M as well as Acros Organics and provided by Eras Labo, respectively. The latter provided by Eras Labo was further purified by recrystallization in distilled anisole inside a glove box, then dried at 140° C. under a 2 mm Hg pressure.

### Preparation of Electrolyte Solutions

Electrolyte solutions were prepared by providing or mixing the solvents in their respective weight ratios and dissolving the lithium salt in an appropriate amount to yield a 1M solution.

### Example 1

### Determination of Aluminium Corrosion in ethyl (1-fluoroethyl)carbonate (F₁DEC)

An electrolyte solution of 1M LiTFSI in F₁DEC was prepared and cyclic voltammetry was performed using an aluminum foil as working electrode for 100 cyclic potentiodynamic sweeps in a potential rang ranging from 3.3 V (cathodic limit) to 5.1 V (anodic limit). A scan rate of 5 mV sec-1 was applied.

FIG. 1a) shows the cyclovoltammogram for 1M LiTFSI in F₁DEC. As can be taken from the FIG. 1a), after the first cycle the observed current density was significantly decreasing and almost no current could be observed subsequently upon the continuous potentiodynamic sweeps, indicating the initial formation of a protective surface film on the aluminum surface and a thus prevented anodic aluminum dissolution upon further polarization of the aluminum foil. The prevention of aluminum dissolution was further confirmed by a subsequent SEM analysis of the aluminum electrode, which did not show any indication of anodic aluminum dissolution.

### Example 2

### Determination of Aluminium Corrosion in 1-fluoroethyl(2,2,2-trifluoroethyl)carbonate (F₄DEC)

An electrolyte solution of 1 M LiTFSI in F₄DEC was prepared and cyclic voltammetry was performed using aluminum as working electrode for 100 cyclic potentiodynamic sweeps in a potential rang ranging from 3.3 V to 5.1 V. A scan rate of 5 mV sec⁻¹ was applied.

FIG. 1b) shows the cyclovoltammogram for 1M LiTFSI in F4DEC. As can be taken from the FIG. 1b), also for F₄DEC as the solvent only for the initial anodic potentiodynamic sweep an evolving current could be observed and almost no current could be detected subsequently upon the continuous potentiodynamic sweeps, indicating the initial formation of a protective surface film on the aluminum surface and a thus prevented anodic aluminum dissolution upon further polarization of the aluminum foil. The prevention of aluminum dissolution further was confirmed by a subsequent SEM analysis of the aluminum electrode, which showed no aluminum dissolution.

This shows that the utilization of linear fluorinated carbonates as electrolyte solvent for LiTFSI-based electrolytes revealed a similar electrochemical behavior as for the utilization of LiPF₆ as lithium salt. In fact, no aluminum corrosion could be observed on the aluminum foil subsequently, even after 100 potentiodynamic cyclic sweeps.

### Example 3

### Determination of Aluminium Corrosion in a Binary Mixture of F₁DEC and F₁EC

An electrolyte solution of 1M LiTFSI in a binary mixture of 50 wt.-% F₁DEC and 50 wt.-% F₁EC was prepared and cyclic voltammetry was performed using aluminum as working electrode for 100 cycles in a potential rang ranging from 3.3 V to 5.1 V. A scan rate of 5 mV sec⁻¹ was applied.

FIG. 2 shows the cyclovoltammogram of 1 M LiTFSI in the binary mixture of F₁DEC and F₁EC (1:1). As can be taken from the FIG. 2, for the binary solvent mixture of F₁DEC and the cyclic fluorinated F₁EC, the observed current density increased starting from around 3.8 V. However, no evolving current could be detected for the subsequent potentiodynamic sweeps, indicating the presence of a protective layer on the aluminum surface formed upon the initial anodic sweep, preventing continuous anodic aluminum dissolution (“corrosion”). Accordingly, no pitting corrosion could be observed for a subsequent ex situ SEM analysis of the electrochemically studied aluminum foil.

Apparently, 50 wt. % of the linear fluorinated carbonate are sufficient to prevent anodic aluminum dissolution by the formation of a protective surface film, enabling an increased flexibility of tailoring suitable electrolyte formulations, possessing enhanced electrochemical characteristics in terms of e.g. ionic conductivity.

### Example 4

### Determination of Aluminium Corrosion in a Ternary Mixture of F₁DEC, F₁EC and F₂EC

An electrolyte solution of 1 M LiTFSI in a ternary mixture of F₁DEC, F₁EC, and F₂EC in a weight ratio of 1:1:1 was prepared and cyclic voltammetry was performed using aluminum as working electrode for 100 cycles in a potential rang ranging from 3.3 V to 5.1 V. A scan rate of 5 mV sec⁻¹ was applied.

FIG. 3 shows the cyclovoltammogram of 1 M LiTFSI in a ternary mixture of F₁DEC, F₁EC and F₂EC (1:1:1). For the ternary solvent mixture the characteristic shape of the first cyclo voltammogram could be observed as was for the pure linear fluorinated carbonates (examples 1 and 2) as well as for the binary solvent mixture (example 3), indicating the initial passivation of the aluminum surface, leading to a prevention of subsequent anodic aluminum dissolution. Nevertheless, the initially detected evolving current is significantly lower than for the former electrolyte solutions, indicating a beneficial effect of F₂EC. Moreover, subsequent SEM analysis confirmed that the aluminum foil did not show any indication of severe pitting corrosion.

### Example 5

### Determination of Ionic Conductivity of LiTFSI in Fluorinated Carbonates and Mixtures Therof

A study on the conductivity of primary and binary electrolyte solvents comprising LiTFSI as lithium salt was performed using electrolyte solutions of 1M LiTFSI in cyclic F₁EC, F₂EC, and F₁EC and F₂EC (1:1), linear F₁DEC and F₄DEC, and binary mixtures of F₁DEC and F₁EC (1:1), F₄DEC and F₁EC (1:1), F₁DEC and F₂EC (1:1), F₄DEC and F₂EC (1:1), as well as for 1 M LiTFSI in DMC and EC and DMC (1:1) as references.

For this purpose, electrical impedance measurements were carried out on a Hewlett-Packard 4192A impedance analyzer, using a two platinum electrode configuration in Radiometer® cells. Measurements were conducted in a temperature range of −30° C. to +60° C. in a frequency range of 13 MHz to 5 Hz applying a 0.03 V alternated voltage with an equilibration time of 1.5 hours. Measurements were averaged on nine points per decade. All electrolyte samples were prepared in and transferred to Jacomex® glove boxes with a water content of less than 10 ppm.

FIG. 4 illustrates the ionic conductivities of 1M LiTFSI in the different solutions of linear fluorinated carbonates and binary solvent mixtures of linear and cyclic fluorinated carbonates. As can be taken from the FIG. 4, the ionic conductivity was further improved by utilizing secondary solvent mixtures of linear and cyclic fluorinated carbonates, illustrating the suitability of such electrolyte compositions for practical applications.

### Example 6

### Determination of the Electrochemical Performance of a Carbon Coated LiFePO₄ Electrode in an Electrolyte of 1M LiTFSI in F₁DEC

An electrolyte solution of 1M LiTFSI in F₁DEC was prepared and electrochemical characterization was performed as described above. FIG. 5 illustrates the electrochemical performance of a carbon coated LiFePO₄ (LFP) electrode in a solution of 1M LiTFSI in F₁DEC. FIG. 5a) shows the galvanostatic cycling of the Li/LiFePO₄ half cell with Li as reference electrode. Cut-off potentials were at 2.8-4.0 V. As can be taken from FIG. 5a), the LFP electrode showed a high efficiency. FIG. 5b) shows the potential profile comparison of Li/LiFePO₄ half cell with Li as reference electrode with 1 M LiPF₆ in EC/DMC (1:1) (LP30) as electrolyte; Cut-offs: 2.8-4.0 V; 1st cycle (C/10). As can be taken from FIG. 5b), the LFP electrode showed a higher capacity in the F₁DEC electrolyte compared to the standard electrolyte with 1 M LiPF₆ in EC/DMC (1:1) (LP30), while the characteristic shape of the LFP potential profile was well preserved.

### Example 7

### Determination of the Electrochemical Performance of a LiNi_{1/3}Mn_{1/3}Co_{1/3}O₂ (NMC) Half Cell

An electrolyte solution of 1M LiTFSI in F₁DEC was prepared and electrochemical characterization was performed as described above. FIG. 6 summarizes the electrochemical performance of LiNi_{1/3}Mn_{1/3}Co_{1/3}O₂ (NMC) half cell in a solution of 1 M LiTFSI in F₁DEC. FIG. 6a) shows the galvanostatic cycling comparison of the Li/LiNi_{1/3}Mn_{1/3}Co_{1/3}O₂ half cell with Li as reference electrode and 1 M LiPF₆ in EC/DMC (1:1) (LP30) as electrolyte; Cut-offs: 3.0-4.3 V. It can be taken from FIG. 6a) that the efficiency for F₁DEC was slightly higher than for the standard LP30 electrolyte. FIG. 6b) shows the potential profile comparison of Li/LiNi_{1/3}Mn_{1/3}Co_{1/3}O₂ half cell with Li as reference electrode with 1 M LiTFSI in F₁DEC and 1 M LiPF₆ in EC/DMC (1:1) (LP30) as electrolyte; Cut-offs: 2.8-4.0 V; 1st cycle (C/10). As can be taken from FIG. 6b), there was no difference of the capacity in the 1st cycle detected between the NMC electrode in the F₁DEC electrolyte compared to the NMC electrode in the standard electrolyte of 1 M LiPF₆ in EC/DMC (1:1) (LP30), confirming that such electrolyte compositions are suitable for commercially used lithium-ion cathode materials.

### Example 8

### Determination of the Electrochemical Performance of LiNi_{1/3}Mn_{1/3}Co_{1/3}O₂ (NMC) in a Binary Electrolyte Solution of 1 M LiTFSI in F₁DEC/F₁EC

An electrolyte solution of 1M LiTFSI in F₁DEC/F₁EC in a weight ratio of 1:1 was prepared and electrochemical characterization was performed as described above. FIG. 7 shows the electrochemical performance of the LiNi_{1/3}Mn_{1/3}Co_{1/3}O₂ (NMC) half cell in a binary mixture of 1 M LiTFSI in F₁DEC and F₁EC in a ratio of 1:1. The figure shows the galvanostatic cycling comparison of Li/LiNi_{1/3}Mn_{1/3}Co_{1/3}O₂ half cell with Li as reference electrode with 1 M LiTFSI in F₁EC/F₁DEC (1:1) and 1 M LiPF₆ in EC/DMC (1:1) (LP30) as electrolyte with Cut-offs at 3.0-4.3 V.

FIG. 7 illustrates that the specific capacity as well as the cycling stability and high rate performance of the NMC electrode in the binary mixture of linear and cyclic fluorinated carbonate F₁DEC/F₁EC electrolyte is comparable to the NMC electrode in the standard electrolyte of 1 M LiPF₆ in EC/DMC (1:1) (LP30). Moreover, a coulombic efficiency of almost 100% is obtained, highlighting once more the suitability of such electrolyte compositions for practical lithium-ion applications.

### Example 9

### Determination of the Electrochemical Performance of LiNi_{1/3}Mn_{1/3}Co_{1/3}O₂ (NMC) in a Ternary Electrolyte Solution of 1 M LiTFSI in F₁DEC/F₁EC/F₂EC

An electrolyte solution of 1M LiTFSI in F₁DEC/F₁EC/F₂EC in a weight ratio of 1:1:1 was prepared and electrochemical characterization was performed as described above. FIG. 8 presents the electrochemical performance of a LiNi_{1/3}Mn_{1/3}Co_{1/3}O₂ (NMC) half cell in a ternary mixture of 1M LiTFSI in F₁DEC, F₁EC and F₂EC in a ratio of 1:1:1. FIG. 8 shows the galvanostatic cycling comparison of Li/LiNi_{1/3}Mn_{1/3}Co_{1/3}O₂ half cell with Li as reference electrode with 1 M LiTFSI in F₁EC/F₂EC/F₁DEC (1:1:1) and 1 M LiPF₆ in EC/DMC (1:1) (LP30) as electrolyte; Cut-offs: 3.0 to 4.3 V. Once again, FIG. 8 illustrates that the specific capacity as well as the efficiency of the NMC electrode in the ternary mixture of linear and cyclic fluorinated carbonates is highly comparable to the electrode performance in the standard electrolyte.

The examples 7 to 9 using common lithium-ion battery cathode materials (LiFePO₄ (LFP) and LiNi_{1/3}Mn_{1/3}Co_{1/3}O₂ (NCM) confirm that the electrolyte compositions can be readily used for lithium-ion cells and are sufficiently stable towards oxidation, also in presence of transition metal oxides and phosphates, delivering a highly similar specific capacity, cycling stability, and electrochemical performance as observed for commercial LP30 (EC:DMC (1:1), 1M LiPF₆).

### Example 10

### Determination of the Electrochemical Performance of a LiNi_{0.4}Mn_{1.6}O₄ Half Cell

An electrolyte solution of 1M LiTFSI in F₄DEC was prepared and electrochemical characterization was performed as described above. FIG. 9 summarizes the electrochemical performance of a LiNi_{0.4}Mn_{1.6}O₄ half cell in a solution of 1 M LiTFSI in F₄DEC. FIG. 9a) shows the galvanostatic cycling of Li/LiNi_{9.4}Mn_{1.6}O₄ half cell with Li as reference electrode; Cut-offs: 3.5-4.95 V. FIG. 9b) shows the corresponding potential profiles of the Li/LiNi_{0.4}Mn_{1.6}O₄ half cell; Cut-offs: 3.5-4.95 V; 2nd (C/10) and 3rd (C/10) cycle.

These data indicate that F₄DEC appears as a promising base-electrolyte solvent for high voltage cathode materials, as for instance LiNi_{0.4}Mn_{1.6}O₄ after a first activation cycle. By combining a second or third co-solvent as illustrated for F₁DEC in examples 3 to 5, the ionic conductivity and the solubility of LiTFSI in F₄DEC at ambient temperature can be further optimized.

### Example 11

### Determination of the Electrochemical Performance of a Graphite Half Cell

An electrolyte solution of 1M LiTFSI in F₁DEC/F₁EC in a weight ratio of 1:1 was prepared and electrochemical characterization was performed as described above. FIG. 10 summarizes the electrochemical performance of the graphite (SLP30) half cell in a binary mixture of 1 M LiTFSI in F₁DEC/F₁EC. FIG. 10a) shows the galvanostatic cycling comparison of graphite (SLP30) half cell with Li as reference electrode with 1M LiTFSI in F₁EC/F₁DEC (1:1) and of 1 M LiPF₆ in EC/DMC (1:1) (LP30) as electrolyte; Cut-offs: 0.02 and 1.5 V. Comparing the electrochemical performance of graphite-based electrodes in fluorinated carbonate-based electrolyte and LP30 as a standard electrolyte, it is obvious that the graphite electrode shows a superior cycling stability, specific capacity, and rate capability, while both show a high coulombic efficiency of up to 100%.

Hence, it is shown that such fluorinated carbonate-based electrolytes are not only suitable for current state-of-the-art lithium-ion cathode materials, but moreover for graphite as state-of-the-art lithium-ion anode, confirming that such electrolyte compositions can be readily utilized in state-of-the-art lithium-ion cells and batteries.

FIG. 10b) shows selected potential profiles for graphite (SLP30) half cell comprising 1M LiTFSI-F₁EC/F₁DEC (1:1) and 1M LiPF6-EC/DMC (1:1) as electrolyte. In fact, both cells show the characteristic potential profile, indicating the different stages of lithium ion (de-)intercalation.

### Comparative Example 12

### Measurement of Low Amounts of F₁DEC in Cyclic Fluorinated Carbonates

To investigate whether for the beneficial effect of the linear fluorinated carbonates already the addition of only little amounts to common organic electrolytes might be sufficient, electrolyte compositions of 1M LiTFSI in F₁EC/F₂EC (1:1) comprising 4 wt % or 11 wt % of F₁DEC, were tested.

Electrolyte solutions of 1 M LiTFSI in F₁EC/F₂EC (1:1) containing either 4 wt % or 11 wt % of F₁DEC were prepared and cyclic voltammetry was performed using an aluminum foil as working electrode for 100 cycles in a potential rang ranging from 3.3 V (cathodic limit) to 5.1 V (anodic limit). A scan rate of 5 mV sec⁻¹ was applied.

The cyclovoltammograms showed a continuously increasing evolving current density during the continuous potentiodynamic sweeps, indicating a continuous anodic aluminum dissolution, which illustrates that 4 wt. % or 11 wt. % of F₁DEC in cyclic fluorinated carbonates do not appear to be sufficient to protect the aluminum current collector. Considerable marks of aluminum dissolution (“pitting corrosion”) were further confirmed by subsequent SEM analysis of the aluminum electrodes.

This shows that a use as simple additive (weight content of the linear fluorinated carbonate ≦11 wt. %) is not sufficient to initially form a protective passivation layer on the aluminum surface in order to suppress aluminum current collector corrosion in solvents of cyclic fluorinated carbonates.

### Example 13

### Measurement of 20 wt % and 33 wt % of F₁DEC in Cyclic Fluorinated Carbonates

To further investigate the linear fluorinated carbonates, electrolyte compositions of 1M LiTFSI in F₁EC/F₂EC (1:1) comprising 20 wt % or 33 wt % of F₁DEC, were tested. Electrolyte solutions of 1 M LiTFSI in F₁EC/F₂EC (1:1) containing either 20 wt % or 33 wt % of F₁DEC were prepared and cyclic voltammetry was performed using an aluminum foil as working electrode for 100 cycles in a potential range ranging from 3.3 V (cathodic limit) to 5.1 V (anodic limit). A scan rate of 5 mV sec⁻¹ was applied.

FIG. 11a) shows the cyclovoltammogram for a 1M solution of LiTFSI in the mixture of 20 wt % of F₁DEC in a solvent mixture of cyclic fluorinated carbonates F₁EC and F₂EC in a weight ratio of 1:1 after for 100 cycles. The cyclovoltammogram illustrates a clear improvement relatively to the use of 11 wt. %. As can be taken from FIG. 11a) the detected evolving current density increases upon the first five cyclic potentiodynamic sweeps before it decreases subsequently rather rapidly, indicating the formation of a passivation layer within the first five cyclic sweeps. Subsequent SEM analysis of the aluminum electrodes did not show any severe marks of aluminum corrosion. This confirms that 20 wt. % of F₁DEC provide a just sufficient passivation of the aluminum current collector.

FIG. 11b) shows the cyclovoltammogram for a 1M solution of LiTFSI in the mixture of 33 wt % of F₁DEC in F₁EC and F₂EC (1:1) after for 100 cycles. As can be taken from the FIG. 11b) no evolving current was detected for the second and subsequent potentiodynamic sweeps. The prevention of aluminum dissolution further was confirmed by a subsequent SEM analysis of the aluminum electrode, which showed no marks of aluminum dissolution.

This shows that the utilization of 33 wt. % of the linear fluorinated carbonate F₁DEC as electrolyte solvent for LiTFSI appears to be more than sufficient for a proper passivation of the aluminum current collector.

### Comparative Example 14

### Measurement of Low Amounts of F₁DEC in Non-Fluorinated Carbonates

In parallel to comparative example 12, also the effect of 11 wt % of the linear fluorinated carbonate F₁DEC in non-fluorinated carbonates was investigated.

An electrolyte solution of 1 M LiTFSI in EC/DMC (1:1) containing 11 wt % of F₁DEC was prepared and cyclic voltammetry was performed using an aluminum foil as working electrode for 100 cycles in a potential rang ranging from 3.3 V (cathodic limit) to 5.1 V (anodic limit). A scan rate of 5 mV sec⁻¹ was applied.

The cyclovoltammograms showed a continuously increasing evolving current density during the continuous potentiodynamic sweeps, which illustrates that 11 wt. % of F₁DEC in non-fluorinated carbonates is not sufficient to protect the aluminum current collector. Furthermore, obvious marks of aluminum dissolution were illustrated by subsequent SEM analysis of the aluminum electrode.

This shows that a use of 11 wt % of the linear fluorinated carbonate F₁DEC in non-fluorinated carbonate-based electrolytes is obviously not sufficient to initially form a suitable passivation layer on the aluminum surface, thus protecting the aluminum current collector from corrosion.

### Example 15

### Measurement of 25 wt % and 33 wt % of F₁DEC in Non-Fluorinated Carbonates

Further, electrolyte compositions of 1M LiTFSI in non-fluorinated carbonates comprising 25 wt % or 33 wt % of F₁DEC were tested. Electrolyte solutions of 1M LiTFSI in EC/DMC (1:1) containing either 25 wt % or 33 wt % of F₁DEC were prepared and cyclic voltammetry was performed using an aluminum foil as working electrode for 100 cycles in a potential rang ranging from 3.3 V (cathodic limit) to 5.1 V (anodic limit). A scan rate of 5 mV sec⁻¹ was applied.

FIG. 12a) shows the cyclovoltammogram for a 1M solution of LiTFSI in a mixture of 25 wt % of F₁DEC in a solvent mixture of non-fluorinated carbonates EC and DMC in a weight ratio of 1:1 during 100 cycles. The cyclovoltammogram illustrates an aluminum passivation within the first cycles by using 25 wt % of F₁DEC. FIG. 12b) shows the cyclovoltammogram for a 1M solution of LiTFSI in a mixture of 33 wt % of F₁DEC in EC/DMC in a ratio of 1:1 for 100 cycles. As can be taken from the FIG. 12b), a F₁DEC content of around 33 wt. % appears preferable with respect to the occurring current within the initial cycles, indicating a more effective aluminum passivation.

### Example 16

### Determination of the Electrochemical Stability Window (ESW)

For the determination of the ESW of several electrolyte compositions a platinum wire was used as working electrode while lithium foils were used as counter and reference electrodes and the cell was polarized up to 6.0 V. An evolving current of 0.01 mA was defined as stability limit, indicating the anodic decomposition of the investigated electrolyte compositions.

FIG. 13 illustrates the determination of the electrochemical stability window (ESW) of fluorinated and non-fluorinated organic carbonate solvents with 1M LiTFSI as conductive salt. As can be taken from FIG. 13, for an electrolyte solution of 1 M LiTFSI in EC/DMC (1:1) the oxidative ESW maximum vs. Li/Li⁺ was determined as 5.84 V, in F₁DEC the oxidative ESW maximum was 5.56 V, in F₁DEC/F₁EC (1:1) it was 5.52 V, in EC/DMC (1:1) 5.49 V, and in F₁EC it was 5.45. This confirms that the electrolyte compositions comprising linear fluorinated carbonates are stable at least up to 5 V, which is well above the solid state redox potentials of currently used and investigated lithium-ion cathode materials.

### Example 17

### Investigation of lithium(nonafluoro butan-2-one sulfonyl)(trifluoromethylsulfonyl)imide

An electrolyte solution of 1M lithium(nonafluoro butan-2-one sulfonyl)(trifluoromethylsulfonyl)imide (salt A) in a ternary mixture of F₁EC/F₁DEC/F₃DEC in a mol ratio of 3:0.5:0.5 was prepared and cyclic voltammetry was performed using an aluminum foil as working electrode for 100 cycles in a potential rang ranging from 3 V to 5 V. A scan rate of 2 mV sec⁻¹ was applied.

FIG. 14 presents the cyclovoltammogram for 100 cycles, showing the characteristic behaviour (see e.g. FIG. 1 a and b) of an initially evolving current, indicating the formation of a protective passivation layer on the aluminum surface, successfully preventing a continuous anodic aluminum dissolution upon the subsequent cyclic potentiodynamic sweeps, which is confirmed by the zero current.

Also the optical microscope images of the utilized Al foil, obtained by means of a Leica DM2700 M, showed no marks of aluminum dissolution (“pitting corrosion”). This shows that also for other sulfonimide-based lithium salts aluminum dissolution can be prevented by using the linear fluorinated carbonates of the invention.

The work leading to this invention has received funding from the European Union Seventh Framework Programme (FP7/2007-2013) under grant agreement n^{o} 29100329 AMELIE.

1. An electrolyte solution comprising an electrolyte salt and an electrolyte solvent, wherein the electrolyte solvent comprises a fluorinated acyclic dialkyl carbonate in an amount in the range of ≧10 wt % to ≦100 wt %, referring to a total amount of the electrolyte solvent of 100 wt %.

2. The electrolyte solution according to claim 1, wherein the electrolyte salt is an alkali or alkaline earth metal sulfonimide or sulfonmethide salt.

3. The electrolyte solution according to claim 1, wherein the fluorinated acyclic dialkyl carbonate is an n-fluoro diethyl carbonate according to formula (1) as follows: C₂H₅₋ₓFₓCO₃C₂H_{5-y}F_{y} (1) wherein 1≦x≦5 and 0≦y≦5.

4. The electrolyte solution according to claim 1 or 2, wherein the fluorinated acyclic dialkyl carbonate is selected from the group consisting of a dimethyl carbonate, an ethyl methyl carbonate, a methyl propyl carbonate, an ethyl propyl carbonate, a dipropyl carbonate and mixtures thereof.

5. The electrolyte solution according to claim 1, wherein the electrolyte solvent further comprises at least one cyclic fluorinated carbonate selected from the group consisting of 4-fluoro-1,3-dioxolan-2-one, cis-4,5-difluoro-1,3-dioxolan-2-one, trans-4,5-difluoro-1,3-dioxolan-2-one and mixtures thereof.

6. The electrolyte solution according to claim 1, wherein the electrolyte solution comprises a binary solvent mixture of a fluorinated acyclic dialkyl carbonate and a cyclic fluorinated carbonate selected from the group consisting of 4-fluoro-1,3-dioxolan-2-one, cis-4,5-difluoro-1,3-dioxolan-2-one, and trans-4,5-difluoro-1,3-dioxolan-2-one.

7. The electrolyte solution according to claim 6, wherein the electrolyte solution comprises a mixture of ethyl (1-fluoroethyl)carbonate and 4-fluoro-1,3-dioxolan-2-one in a ratio of 1:1 or 1-fluoroethyl(2,2,2-trifluoroethyl)carbonate and 4-fluoro-1,3-dioxolan-2-one in a ratio of 1:1.

8. The electrolyte solution according to claim 1, wherein the electrolyte solution comprises a ternary solvent mixture of at least one fluorinated acyclic dialkyl carbonate, and at least one cyclic fluorinated carbonate selected from the group consisting of 4-fluoro-1,3-dioxolan-2-one, cis-4,5-difluoro-1,3-dioxolan-2-one, trans-4,5-difluoro-1,3-dioxolan-2-one and mixtures thereof.

9. The electrolyte solution according to claim 8, wherein the electrolyte solution comprises a ternary solvent mixture of ethyl (1-fluoroethyl)carbonate or 1-fluoroethyl(2,2,2-trifluoroethyl)carbonate, 4-fluoro-1,3-dioxolan-2-one, and trans-4,5-difluoro-1,3-dioxolan-2-one in a ratio of 1:1:1.

10. An alkali or alkaline earth metal-based electrochemical energy storage device, comprising an electrolyte solution according claim 1.

11. A method for the suppression or prevention of aluminum current collector corrosion in an alkali or alkaline earth metal-based electrochemical energy storage device containing an electrolyte solution comprising an alkali or alkaline earth metal sulfonimide or sulfonmethide salt, the method comprising using a fluorinated acyclic dialkyl carbonate in an amount in the range of ≧10 wt % to ≦100 wt %, referring to a total amount of an electrolyte solvent of 100 wt %.

12. The method according to claim 11, wherein the alkali or alkaline earth metal sulfonimide salt is selected from the group consisting of lithium bis(trifluoromethanesulfonyl)imide, lithium bis(fluorosulfonyl)imide, LiN(FSO₂)₂, lithium trifluoromethanesulfonate Li(CF₃)SO₃, lithium (trifluoromethylsulfonyl)(nonafluorobutanesulfonyl)imide LiN(SO₂CF₃)(SO₂C₄F₉), lithium (fluorosulfonyl)(nonafluorobutanesulfonyl)imide LiN(SO₂F)(SO₂C₄F₉), lithium(nonafluoro butan-2-one sulfonyl)(trifluoromethylsulfonyl)imide LiN(SO₂C₂F₄OC₂F₅)(SO₂CF₃), lithium (nonafluoro butan-2-one sulfonyl)(fluorosulfonyl)imide LiN(SO₂C₂F₄OC₂F₅)(SO₂F).

13. The method according to claim 11, wherein the electrolyte solvent further comprises at least one cyclic fluorinated carbonate selected from the group consisting of 4-fluoro-1,3-dioxolan-2-one, cis-4,5-difluoro-1,3-dioxolan-2-one, trans-4,5-difluoro-1,3-dioxolan-2-one and mixtures thereof, and/or a non-fluorinated organic carbonate selected from the group consisting of ethylene carbonate, ethyl methyl carbonate, propylene carbonate, dimethyl carbonate, diethyl carbonate and mixtures thereof.

14. The method according to claim 11, wherein the fluorinated acyclic dialkyl carbonate is selected from the group consisting of a dimethyl carbonate, an ethyl methyl carbonate, a methyl propyl carbonate, an ethyl propyl carbonate, a dipropyl carbonate and mixtures thereof.

15. An aluminium current collector comprising a modified surface wherein the modified surface is obtained by contacting the aluminium current collector with an electrolyte solution comprising an electrolyte salt and an electrolyte solvent, wherein the electrolyte solvent comprises a fluorinated acyclic dialkyl carbonate.

16. The electrolyte solution according to claim 2, wherein the electrolyte salt is a lithium sulfonimide salt.

17. The electrolyte solution according to claim 16, wherein the electrolyte salt is selected from the group consisting of lithium bis(trifluoromethanesulfonyl)imide LiN(SO₂CF₃)₂, lithium bis(fluorosulfonyl)imide, LiN(FSO₂)₂, lithium trifluoromethanesulfonate Li(CF₃)SO₃, lithium(trifluoromethylsulfonyl)(nonafluorobutanesulfonyl)imide LiN(SO₂CF₃)(SO₂C₄F₉), lithium(fluorosulfonyl)(nonafluorobutanesulfonyl)imide LiN(SO₂F)(SO₂C₄F₉), lithium (nonafluorobutan-2-one sulfonyl)(trifluoromethylsulfonyl)imide LiN(SO₂C₂F₄OC₂F₅)(SO₂CF₃), lithium(nonafluorobutan-2-one sulfonyl)(fluorosulfonyl)imide LiN(SO₂C2F₄OC₂F₅)(SO₂F) and mixtures thereof.

18. The electrolyte solution according to claim 3, wherein the n-fluoro diethyl carbonate is selected from the group consisting of ethyl (1-fluoroethyl)carbonate, 1-fluoroethyl(2,2,2-trifluoroethyl)carbonate, bis(2-fluoroethyl)carbonate, bis(2,2,2-trifluoroethyl)carbonate, bis(1,2,2-trifluoroethyl)carbonate and mixtures thereof.

19. The electrolyte solution according to claim 18, wherein the n-fluoro diethyl carbonate is selected from the group consisting of ethyl (1-fluoroethyl)carbonate, 1-fluoroethyl(2,2,2-trifluoroethyl)carbonate and mixtures thereof.

20. The electrolyte solution according to claim 4, wherein the fluorinated dialkyl carbonate is selected from the group consisting of fluoromethyl methyl carbonate, bis(fluoromethyl)carbonate, fluoromethyl ethyl carbonate, fluoromethyl n-propyl carbonate, fluoromethyl isopropyl carbonate, 1-fluoroethyl methyl carbonate, 2-fluoroethyl methyl carbonate, 2,2,2-trifluoroethyl methyl carbonate, 2,2,2-trifluoroethyl fluoromethyl carbonate, 2,2-difluoroethyl methyl carbonate, 2,2-difluoroethyl fluoromethyl carbonate and mixtures thereof.
